(19) United States
(12) Patent Application Publication
(10) Pub. No.: US 2011/0010087 A1
(43) Pub. Date: Jan. 13, 2011

(54) Home Health Point-of-Care and Administration System

(75) Inventors: Michael K. Wons, Naperville, IL (US); Andrew M. Kaboff, Vernon Hills, IL (US); Steven A. Wegner, Bartlett, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: CELLTRAK TECHNOLOGIES, INC., Schaumburg, IL (US)

(21) Appl. No.: 12/848,639

(22) Filed: Aug. 2, 2010

Related U.S. Application Data
(63) Continuation-in-part of application No. 11/586,325, filed on Oct. 24, 2006.
(60) Provisional application No. 60/729,556, filed on Oct. 24, 2005.

(51) Int. Cl. G06Q 50/00; G01C 21/00

(52) U.S. Cl. 701/201; 705/2

(57) ABSTRACT

A home health point-of-care and administration system and method that has at least one communication device that is adapted to establish bi-directional communication with a server system is provided. One or more input components of the communication device allow for input of information from a user (such as a visiting home healthcare staff member) and the communication device is adapted for receipt of instructional and other information from the server system. The information includes details related to off-site visits such as tasks performed by the visiting staff member using the communication device. Start and finish times of the visit may also be recorded. A global positioning system (GPS) application operating in conjunction with the communication device and server system may be employed to monitor the actions of the visiting staff member. Such information may be provided in individual visit records and may be used for administrative purposes.

This application is a continuation-in-part of prior application Ser. No. 11/586,325, filed Oct. 24, 2006, which claims the benefit of U.S. Provisional Application No. 60/729,556, filed Oct. 24, 2005, the entire contents (including the source code appendix) of both which are hereby incorporated by reference herein.

### BACKGROUND

The home healthcare industry is a multi-billion dollar field. Instead of requiring patients to undergo prolonged hospital stays or frequent visits to a clinic, a home care agency brings the medical services to the patient's location. Payment for services rendered is primarily paid by federal and state Medicare and Medicaid programs. Patient well-being often depends on the visit and attendance compliance of the visiting nurse, aide, or therapist, for example.

Home healthcare agencies dispatch nurses, aides, and therapists to the homes of patients to perform required healthcare assessments, tasks, and other vital services. The frequency and length of time of a visit and the care provided by the visiting professional are important to obtaining a positive outcome and improving the health of the patient. Government reimbursement to a home healthcare agency is paid on a per episode (sickness) basis; therefore, the visiting nurse is often required to recommend the frequency and type of visits by a caregiver. Thus, it is important to ensure compliance by the caregiver in attending the needed visits, and knowing what tasks and services are required for the specific patient. Tracking the duration of the actual visit is also important. Homecare agency administrators are then responsible for processing patient visit data records generated by the visiting staff to be transferred into billing, scheduling, and payroll systems.

Certain home healthcare reporting systems and processes rely on the visiting staff to self report their visit attendance performance. Disadvantageously, at times this results in increased miscommunication, fraud, and abuse by the visiting caregiver. The administrative staff of the home healthcare agency is faced with monitoring the off-site personnel by spot-checking visit attendance data or relying on patient complaints or feedback.

Another disadvantage to such self-reporting procedures is that the reporting is generally self-documented by visiting staff on paper reports. A full time visiting staff employee can perform over 1250 visits a year, which could require a typical administrative staff person to spend an average of five minutes or more per employee visit to process and enter the information into appropriate billing, scheduling, and payroll systems. This can be inefficient and costly. Accordingly, there is a need for a system that provides for improved monitoring, reporting, data communication, and/or tracking of information relating to field service personnel such as visiting staff in the home healthcare field.

### OVERVIEW

A home health point-of-care and administration system is provided that, in various embodiments, may track visiting staff members during working hours and further prompt the visiting staff to interact with one or more computer-based tracking and data communication program modules. Interaction with the modules may occur via a communication device, such as a mobile or wireless telephone, a plain old telephone service (POTS) device, or any other device. The tracking and communication modules associated with one or more computer-based communication devices may provide for bi-directional communication and build a patient visit record dynamically based on the specific services required for the patient. For example, the visiting staff may start a visit by entering a patient record number, alpha numeric data, or other data into the communication device via a user interface, such as a keypad, touchscreen, or other mechanism for receiving input. A visit record may then be generated and sent to an office administration server system, and the administration may be alerted that a visit is starting for a specific patient. In one example, the server system automatically responds to the visit that is starting and provides to the visiting staff member via the communication device the specific list of tasks, vitals, and services to be performed for the patient. Alternatively, information and task instructions may be manually inputted by an administrator and sent to the visiting staff member via the communication device.

By receiving this information from the administrative computer-based server system, the visiting staff member may be informed of specifically what patients are on his or her schedule, of an optimized route to take to visit each patient, and of what to do for that patient. A patient specific visit record may also be generated. The administrative staff persons at the home office (server system) may then be informed that a visit has started, of the time and date it started, of the staff person that is performing the homecare visit, and what the visiting staff person was told to do for the specific patient. By way of example only, the present specification describes embodiments related to systems and methods of data collection, reporting, and tracking of in-field home healthcare personnel. However, it is understood that the present invention may encompass and apply to various systems and methods and is intended to relate to alternative embodiments for use in communicating information with, and the monitoring of, any type of field service personnel.

The home health point-of-care and administration system may start a visit by creating a patient and visiting staff electronic visit record at the point-of-care. The record may selectively be customized to each specific patient each time a new visit is started. The record allows the visiting staff person to enter patient-specific vitals, identify patient conditions, and report service performed, all via the communication device. The record may store the time associated with the visit time or other information, perhaps by using a clock associated with the communication device or the server system. Preferably, the communication device employed by the visiting staff user is capable of communicating data over the Internet. Additionally or alternatively, the communication device may be any type of telephonic device, personal digital assistant (PDA), personal computer (PC), or any other type of bi-directional communication device capable of transmitting and receiving data. The communication device is preferably a computer-based device that has an associated memory for storage of data communication software and personnel/device tracking software. The communication device may also contain one or more processors for executing the software stored in the memory. It is understood that the communication and tracking software can be operated on various types of mobile or cellular telephones, personal digital assistants (PDA), portable personal computers (PC) or any type of mobile device capable of conducting bi-directional communications that can receive and enter alpha and numeric data from a field location such as at the point-of-care location of a patient. In one embodiment, the completed visit record is electronically sent by the communication device over the Internet (or other communication network) to a server system and the open visit record in progress is automatically filled out and completed. Accordingly, a real-time paperless dynamic patient specific record may be provided to appropriate administrative staff that may include, for example, vital patient data in real-time. Provision of this record in real-time tends to reduce errors, expedite the data entry, reduce expenses and improve patient outcomes and reduces the chances of staff fraud and abuse.

In one aspect, the system provides electronic data collection and reporting. Interaction with the communication device by the user establishes a visitation record through real-time data communication with the application server computer. A complete visit compliance record is created in paperless fashion and real-time confirmation of a completed visit is provided. A global positioning system (GPS) may also be associated with the communication device (as well as the server system) to provide for real-time tracking and recording of the user's location (such as visiting homecare staff personnel), and to determine a traveled path of the user. Estimated speed and length of travel are used in conjunction with the GPS application for automatically calculating accurate mileage of the user. User travel is tracked from location to location such that mileage to the 100^{th} of a mile may be determined. A shortest distance from location to location as the user is traveling between visits may be determined. The travel path between locations or visits may be automatically determined and recorded in real-time for accurate mileage recordation.

In one example, when the user begins or starts a visit, perhaps to the home of a patient, the user may move through a menu provided on a screen of the communication device and select a “start visit” application through interaction with the input device. The user may then enter an identification number associated with the patient or enter other related visit data, which is recorded in real-time. Once the visitation is started and the time and date information is recorded, the user may input various information relating to the patient in response to various prompts that appear at the display of the communication device, as seen in FIGS. 7A and 7B.

In another aspect, the system provides data collection and reporting via a POTS telephone device. The system may include-text-to-speech capabilities for converting text representations of various information relating to the patient into an audio representation. The system may then convey the audio representation to the caregiver. The system may also include speech recognition software for receiving audio representations of patient information from a caregiver. The system may convert the audio representation into a text representation for storage.

The communication device, which is operated by the user, may provide various screen displays or prompts to the user at the start of a visit. Additionally, the communication device may provide displays or prompts to the user related to the assignment of various tasks to be performed by the user during the in-field activity (e.g. during a patient visit). The displays or prompts provided by the communication device may instruct the user to input information related to the in-field activity such as information related to a patient and a patient visit (see FIGS. 7A and 7B). Various tasks are performed and completed by the user and certain requested information is inputted (and perhaps stored in a memory of the communication device). Once the tasks are completed and the user inputs necessary information, for example information relating to a patient and a patient visit, the client application may provide a finish visit prompt (e.g. providing a “finish” display on the display screen) to end the visit and complete recordation of the associated information related to the visit. Time and date information are recorded as well as the information accumulated in relation to the visit. Such information associated with the visit may be stored in memory at the computer-based communication device for transmission to a remote server system, and/or could be stored in a memory of the server system, among other possibilities.

The data information inputted at the client communication device is transmitted through a communications network, such as the Internet or POTS, and is recorded at a server system. As discussed, the visit information may be captured and stored in real-time. A record may be created and saved relating to the visit (for example a patient specific record containing information associated with the patient visit) and may be used for administrative purposes. The server system may include a web portal computer for establishing proper communication through the Internet or World Wide Web with the communication devices operating in the field. The web portal computer may be coupled to an office/administrative computer or, alternatively, to a display unit for retrieval and viewing of the record information stored that has been received from the in-field communication devices. The web portal computer (either alone or in conjunction with other computers or display devices) may provide for the viewing of open visits. An administrator reviewing such records may view, edit or approve of visits and the tasks performed during visits as the information is received by the server system in real-time. Alternatively, such editing or approval of information relating to visits may be performed in an automated fashion by the web portal server or by other computer devices associated therewith. The records established with completed visits (such as records involving home care patient visits) are archived at the server system. The server system may further provide reporting capabilities. Thus, a dynamic electronic record that is personalized to a patient, patient visit or other in-field activity may be created at the communication device and sent via a communication network for receipt by the server system, or may be created at the server system in response to inputs received from the communication device via the communication network, among other possibilities. The information may be sent in real-time (and in a paperless fashion) such that a detailed electronic visit record is provided. For example, for a home visit of a patient, the established record reflecting the visit may selectively include information relating to the services and tasks performed, the vitals obtained relating to the patient, the start/finish times of the visit, information relating to billing, information relating to the in-field health care person using the communication device, and any other information associated with the visit. The real-time bi-directional communication between the server and the communication devices in the field allows for proper visit compliance to be achieved and detailed paperless records to be established for individual visits, which may then be used for monitoring, billing, reporting or other administrative purposes.

As described herein, the home health point-of-care and administration system may include a GPS application for real-time tracking and recording of off-site personnel using GPS-equipped communication devices as they perform tasks in the field. The GPS application allows for monitoring, from the remote server system (or alternative office or computer-based monitoring location), of the position or location of the field staff members as they possess and carry associated communication devices with them from visit to visit. The GPS application is programmed to identify the daily path of travel as the field personnel users transport their respective communication devices with them as they move from each visit location. The GPS application determines the location coordinates of the communication device held by the off-site personnel user and sends the coordinates from the communication device to the remote server system, for example, at predetermined time intervals such as every two minutes. The tracking performed by the GPS application provides for real-time web mapping and accurately tracks the device location within a particular distance range (e.g. 300 ft.) Automatic geofencing of different locations (such as different patient homes) may selectively be performed. The GPS component of the system allows for real-time communication of location information to the remote server system including date/time information, as well as location and duration in place for the visiting staff member. The travel path of the visiting staff member is also mapped out for display at the remote server system and information such as: date and times, each visit location, duration at each visit, and travel time/speed are selectively provided, as seen in FIG. 7C.

### BRIEF DESCRIPTION OF THE DRAWINGS

FIG. 1 is a representative system diagram illustrating a home heath point-of-care and administration system according to an embodiment of the present invention.

FIG. 2 is a simplified block diagram of a communication device, in accordance with an exemplary embodiment.

FIG. 3 is a simplified block diagram illustrating representative modules that may be included in an embodiment of the present invention.

FIG. 3a is a flow chart illustrating the steps associated with initiating and establishing bi-directional communication with the communication device and remote server system.

FIG. 4 is a flow chart illustrating the steps associated with an office administrative process as part of the home care administration system.

FIG. 5 is a flow chart illustrating the steps of a field personnel visitation process associated with a communication device and related tracking as part of the home care administration system.

FIG. 6 is an illustrative diagram representing relationships between communication device field service users/agents, patients, visits by field service users/agents and tasks performed.

FIG. 7A shows pictorial representations of a display screen for a mobile device, showing an initialization procedure, according to one embodiment of the invention.

FIG. 7B shows pictorial representations of a display screen for a mobile device, showing data inputs to complete tasks and a conclusion procedure, according to one embodiment of the invention.

FIG. 7C shows a pictorial representation of a display screen for a web portal server computer, showing a map-based tracking application, according to one embodiment of the invention.

FIG. 8 shows a pictorial representation of a display screen for a web portal server computer, showing a patient database, according to one embodiment of the invention.

FIG. 9 shows a pictorial representation of a display screen for a web portal server computer, showing a task-list editing application, for designing a patient's care plan, according to one embodiment of the invention.

FIG. 10 shows a pictorial representation of a display screen for a web portal server computer, showing a patient record editing interface, according to one embodiment of the invention.

FIG. 11 shows a pictorial representation of a display screen for a web portal server computer, showing a staff scheduling application, according to one embodiment of the invention.

FIG. 12 shows a pictorial representation of a display screen for a web portal server computer, showing a login screen according to one embodiment of the invention.

FIG. 13 shows a pictorial representation of a display screen for a web portal server computer, showing a visit status summary screen, according to one embodiment of the invention.

FIG. 14 shows a pictorial representation of a display screen for a web portal server computer, showing an “open visits” summary screen, according to one embodiment of the invention.

FIG. 15 shows a pictorial representation of a display screen for a web portal server computer, showing an “open visit” details screen, according to one embodiment of the invention.

FIG. 16 shows a pictorial representation of a display screen for a web portal server computer, showing a “pending visits” summary screen, according to one embodiment of the invention.

FIG. 17 shows a pictorial representation of a display screen for a web portal server computer, showing a “pending visits” details screen, according to one embodiment of the invention.

FIG. 18 shows a pictorial representation of a display screen for a web portal server computer, showing an “approved visits” screen, according to one embodiment of the invention.

FIG. 19 shows a pictorial representation of a display screen for a web portal server computer, showing a “patient reports” summary screen, according to one embodiment of the invention.

FIG. 20 shows a pictorial representation of a display screen for a web portal server computer, showing a sample patient report, according to one embodiment of the invention.

FIG. 21 shows a pictorial representation of a display screen for a web portal server computer, showing a “visit history” screen, according to one embodiment of the invention.

FIG. 22 shows a pictorial representation of a display screen for a web portal server computer, showing a “visit alert” screen, according to one embodiment of the invention.

FIG. 23 shows a pictorial representation of a display screen for a web portal server computer, showing an “export queue” screen, according to one embodiment of the invention.

FIG. 24 shows a pictorial representation of a display screen for a web portal server computer, showing a “visit map” screen, according to one embodiment of the invention.

FIG. 25 shows a pictorial representation of a display screen for a web portal server computer, showing a staff listing screen, according to one embodiment of the invention.

FIG. 26 shows a pictorial representation of a display screen for a web portal server computer, showing a report selection screen, according to one embodiment of the invention.

FIG. 27 shows a pictorial representation of a display screen for a web portal server computer, showing an address validation screen, according to one embodiment of the invention.

FIG. 28 shows a pictorial representation of a display screen for a web portal server computer, showing a staff location screen, according to one embodiment of the invention.

FIG. 29 shows a pictorial representation of a display screen for a web portal server computer, showing an office location screen, according to one embodiment of the invention.

FIG. 30 shows a pictorial representation of a display screen for a web portal server computer, showing a staff roles and responsibilities edit screen, according to one embodiment of the invention.

FIGS. 31A and 31B show a pictorial representation of a display screen for a web portal server computer, showing a list of visits conducted using interactive voice response (IVR) or using an application device.

FIG. 32 shows a pictorial representation of a display screen for a web portal server computer, showing a “visit verification report” screen, according to one embodiment of the invention.

FIG. 33 shows a pictorial representation of a display screen for a web portal server computer, showing a mapping verification screen, according to one embodiment of the invention.

FIG. 34 shows a pictorial representation of a display screen for a web portal server computer, showing a second staff location screen, according to one embodiment of the invention.

FIG. 35 shows a pictorial representation of a display screen for a web portal server computer, showing a “patient care plan” screen, according to one embodiment of the invention.

FIG. 36 shows a pictorial representation of a display screen for a web portal server computer, showing an “exported visits” screen, according to one embodiment of the invention.

### DETAILED DESCRIPTION

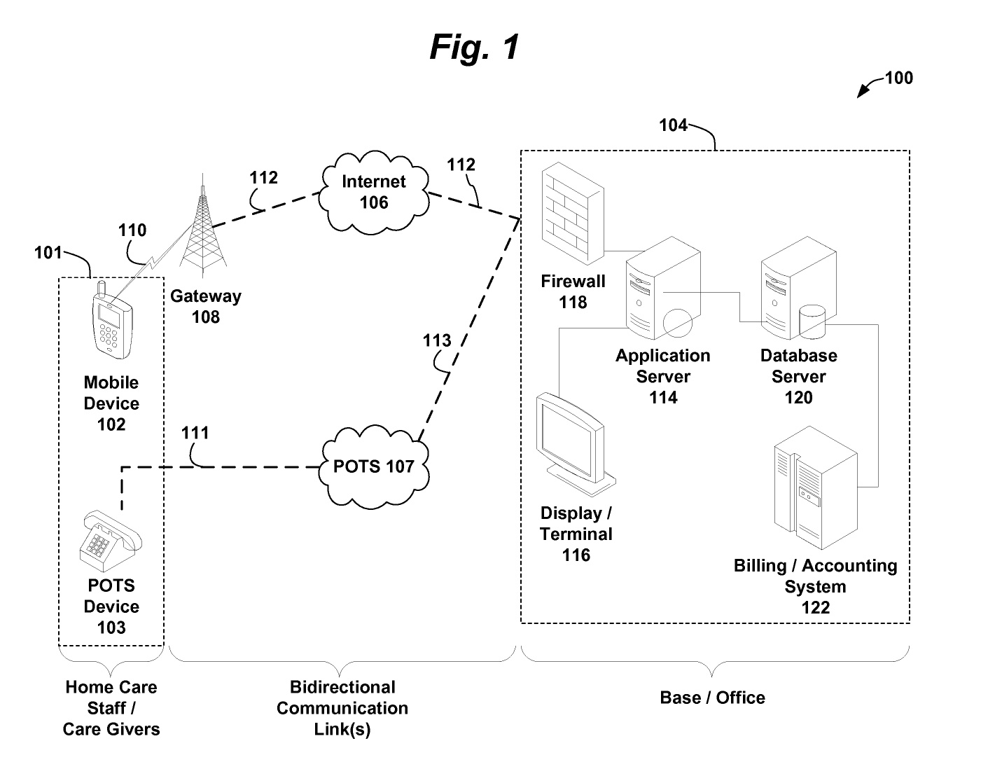

FIG. 1 depicts a home health point-of-care and administration system 100, in accordance with exemplary embodiments. As shown in FIG. 1, system 100 includes one or more mobile application devices 102 and/or plain old telephone system (POTS) devices 103 that may be used by a home-care staff person and/or caregiver to bidirectionally communicate with base/office server system 104 over communication paths 110/112 and/or 111/113. Note that mobile application device 102 and/or POTS device 103 may be generically referred to as communication device 101.

Note that additional entities not shown in FIG. 1 could be present as well. For example, additional communication devices 101 could be present. As other examples, additional entities disposed along communication links 110, 111, 112, and/or 113 could be present, and/or additional server components could be present in server system 104. Also note that one or more of the entities shown in FIG. 1 could be combined into a single entity. For example, application server 114, firewall 118, database server 120, and/or billing/accounting system 122 could be part of a single server machine, and/or each could be a separate server machine, among other combinations and possibilities.

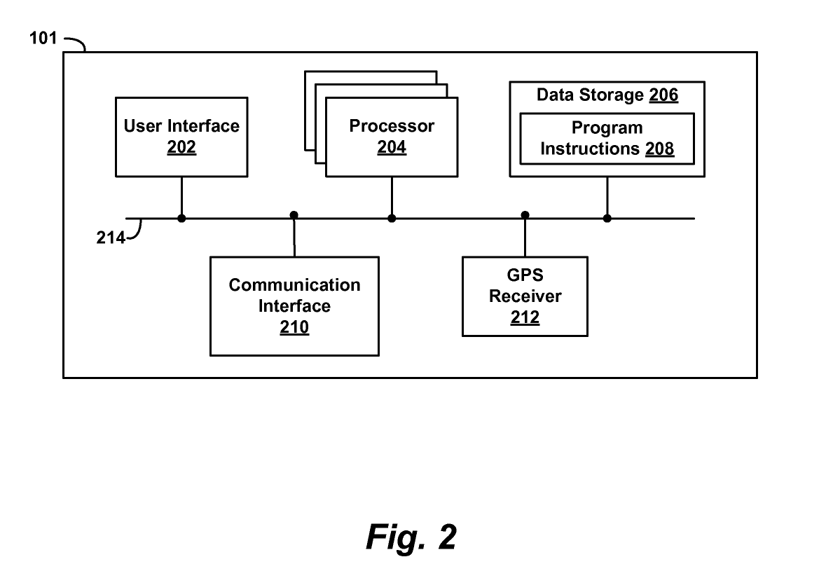

FIG. 2 is a simplified block diagram of communication device 101, in accordance with exemplary embodiments. Communication device 101 may be any device capable of carrying out the communication-device functions described herein. As such, communication device 101 may include user interface 202, processor 204, data storage 206 containing program instructions 208 that are executable by the processor, communication interface 210, and GPS receiver 212, all connected by a system bus 214.

Other entities not shown in FIG. 2 may be present as well, including any other entities now known or later developed for such devices. For example, communication device 101 could include a modem, an imaging device, such as a digital camera and/or video camera, and/or an RFID (Radio-Frequency Identification) module. Further, communication device 101 may contain more than one of any one of the entities depicted in FIG. 2—for example, more than one processor.

Communication device 101 may take the form of or include a mobile device (such as mobile application device 102), a landline telephone (such as POTS device 103), a mobile phone, a personal digital assistant, a computer (such as a notebook computer), and/or an e-book reader, among other possibilities. Mobile application device 102 may be able to execute one or more applications or modules, perhaps using a processor and/or a data storage, and may take the form of a mobile phone, a smartphone, and/or a tablet computer, for example.

Communication device 101 may be used (and is preferably carried) by each home-care staff person and/or caregiver that operates in the field. These persons may include, for example, nurse aides, nurses, therapists, physician assistants, and other medical technicians and/or professionals.

User interface 202 may function to facilitate interaction with a user of communication device 101. As such, user interface 202 could include a keypad, a keyboard, a display, a touchscreen, a loudspeaker, and/or a microphone, and/or any other elements for receiving inputs and/or communicating outputs.

Processor 204 may be, for example, a general-purpose microprocessor and/or a discrete signal processor. Though processor 204 is described here as a single processor, those having skill in the art will recognize that communication device 101 may contain multiple (e.g., parallel) processors, as depicted in FIG. 2.

Data storage 206 may store a set of machine-language program instructions 208 that are executable by processor 204 to carry out various functions described herein. For example, program instructions 208 may allow communication device 101 to provide the following features:
Require a user to enter a username and/or password to prevent unauthorized access to the mobile device and underlying accessible patient data;
Exchange, update, approve, and/or deny staff schedules with the server system 104;
Transmit position updates to the server system 104, using the GPS module;
Accept a patient identification input from the user for an upcoming or current visit to the residence or current location of a particular home care patient;
Download from the server system 104 a patient-specific care plan corresponding to the particular home care patient;
Dynamically render one or more electronic data collection forms corresponding to the downloaded care plan;
Prompt the user to enter data corresponding to the electronic data collection forms;
Accept and validate data entered into the electronic data collection forms by the user;
Receive transmissions from telemedicine devices, such as Bluetooth-enabled weight scales, pacemakers, blood-pressure monitors, and others;
Transmit the entered data and/or completed electronic data collection forms to the server system 104;
Upon determining that no communication link is present, storing entered data offline (on the mobile device) for a period of time, until a communication link is again present;
Receive and display clinical messaging and/or notification from the server system 104;
Capture clinical images and/or video of patient features, such as surgical and wound conditions;
Accept voice annotations from the user, where the voice annotations may be associated with the captured clinical images or other data inputted by the user into the mobile device;
Accept supply order requests from the user and transmit the supply order requests to the server system so that they may be fulfilled; and
Receive messages and alerts from the server system 104 that relate to real-time health conditions for a patient undergoing a home care visit.
   Alternatively, some or all of the functions/features could instead be implemented through hardware. In addition, data storage 206 may store various data to facilitate carrying out various functions described herein. In addition, data storage 206 may hold user-interface data, among many other possibilities.

Communication interface 210 may include a chipset suitable for communicating with one or more devices such as, for example, Internet 106, POTS 107, gateway 108, server system 104, and/or any entity. The communication interface could be suitable for wireless communication, such as CDMA communication, EV-DO communication, Wi-Fi communication, and/or Bluetooth communication, among other possibilities. Additionally or alternatively, the communication interface could be suitable for wired communication, such as Ethernet communication, POTS or public switched telephone network (PSTN) communication, universal serial bus (USB) communication, and/or FireWire communication, as well as other communication. Those having skill in the art will recognize that other types of communication may be possible without departing from the scope of the claims.

GPS receiver 212 could be, for example, any known or hereafter-developed global positioning system (GPS) receiver, suitable for receiving and decoding GPS signals for location and timing purposes, perhaps among other purposes.

With reference again to FIG. 1, server system 104 may be any arrangement of one or more devices capable of carrying out the server-system functions described herein. The server system 104 in the illustrated embodiment includes application server 114 and an associated display 116, a firewall 118, a database servers 120, and a billing/accounting system 122. The various entities that make up server system 104 may be communicatively connected via communication paths, which are described in detail below. The server system may also be connected to a network such as Internet 106 and/or POTS 107. Server system 104 may be a centralized nation-wide central system that provides administration services for several or many home care offices in different regions. Alternatively or additionally, each home care region could be serviced by one or more dedicated server systems 104. Multiple server systems 104 and/or multiple components within the server system 104 may be included in order to provide redundancy and/or load balancing.

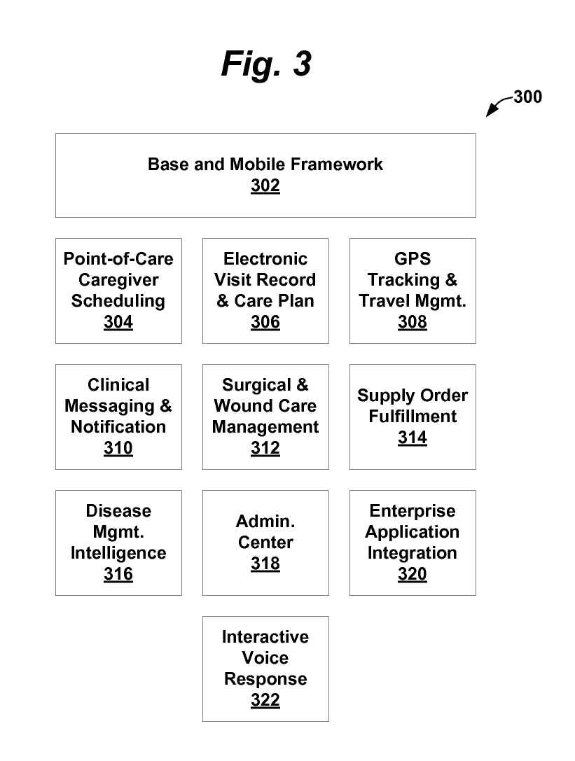

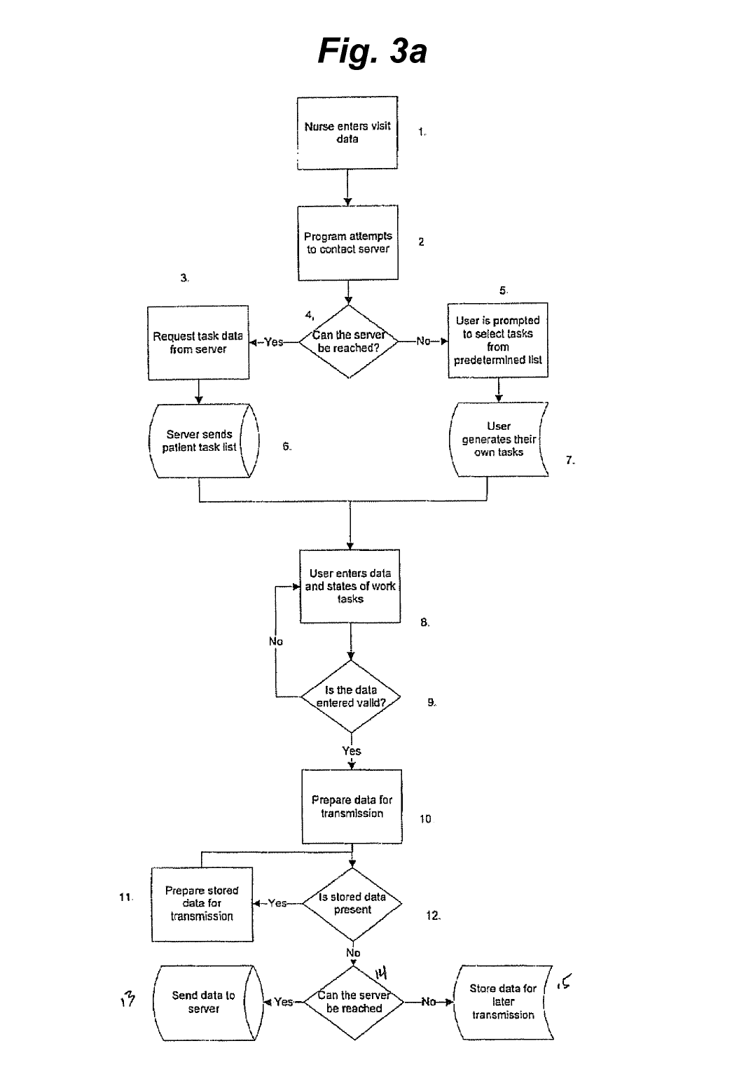

Application server 114 may include, for example, a user interface (such as display/terminal 116), a processor, a data storage containing program instructions that are executable by the processor, and/or a communication interface, all connected by a system bus. The program instructions could include, for example, instructions for executing base and mobile framework 302, and/or any of modules 304 to 322, as depicted in FIG. 3, among other possibilities. Additional elements could be present as well, and any of the described elements could be combined into a single element. Note that firewall 118, database server 120, billing/accounting system 122, or any other entity that makes up server system 104 could comprise a structure similar to that of application server 114.

Internet 106 may be any network capable of facilitating communication between communication device 101 and server system 104. As such, internet 106 could take the form of the wide area network commonly referred to as “the Internet.” POTS 107 may be any telephone network capable of facilitating telephone communication between communication device 101 and server system 104. As such, POTS 107 could be a PSTN, among other possibilities. Any other communication paths or system of paths that make up a communication network could be present as well to facilitate communication between communication device 101 and server system 104.

Gateway 108 may be any entity capable of carrying out the gateway functions described herein. As such, gateway 108 may comprise, for example, a cellular tower, a base station, a Wi-Fi access point, and/or an Internet gateway, among other possibilities, such that communication device 101 (such as mobile application device 102) may be able to communicate with gateway 108 via communication path 110.

Communication paths 110, 111, 112, and 113 may be used to facilitate communication between various entities, such as those entities depicted in FIG. 1. Though the communication paths are depicted as single, unbroken paths, those having skill in the art will recognize that a communication path may comprise multiple (parallel or serial) links

Application server 114 acts as a server to communication device 101 and is preferably provided with a software based web server application that performs many actions such as dynamically managing workforce schedules; viewing open visits; viewing, editing and approving visits; archiving completed visits; and reporting based on monitoring and communicating visit information with communication device 101 used by caregivers and or other home-care staff in the field.

Display/terminal 116 may be used by (for example) office-based staff to interact with application server 114, any other entity that makes up server system 104, or any other entity, and may be used to create, modify, and otherwise interact with care plans, patient information, staff schedules, and other data, among other possibilities. Examples of such devices 116 include desktop PCs, laptop computers, Tablet PCs, workstations, or any other devices. Display/terminal 116 may be capable of connecting to a World Wide Web server to retrieve and display web pages.

Database server 120 may selectively store various types of data that provide assistance in the management and administration of information, such as visit records and field service monitoring reports, obtained as a result of activities (such as home care visits) performed by field service personnel or agents. The database server 120 may be coupled to a local or remote corporate billing/accounting system 122 to provide appropriate billing information based on tasks performed by the field service personnel. A non-exclusive list of the types of information (fields) that may be stored in one or more databases includes: patient demographic information, home care tasks, staff information, locations, visit records, visit status, care plans, actual tasks that are performed in each actual visit, clinical outcomes, and clinical measurements. The one or more databases preferably comprise a Relational Database Management System. For example, a care plan may be maintained as a table having rows and columns corresponding to the stored fields. XML (eXtensible Markup Language) based data structures with associated tags and metadata are preferably used for storing and sharing the home care information among the components of the system 100.

FIG. 3 is a simplified block diagram illustrating representative modules 300 that may be included in an embodiment of the present invention. The modules may comprise a set of program instructions that are executable by a computer or device, such as application server 114, database server 120, billing/accounting system 122, and/or communication device 101, among other possibilities. Additionally or alternatively, the modules may comprise hardware devices capable of carrying out the respective module functions described below.

The modules include an underlying base and mobile framework module 302 and a plurality of functional modules 304 through 322. Note that additional modules not shown could be present as well, and the functionality of two or more modules could be combined into a single module. Each of these modules is described below in the order shown in FIG. 3. While all of the representative modules 300 may be included in certain embodiments of the present invention, some embodiments may be omitted in alternative embodiments, depending on the particular functionality to be provided by the home care administration system.

### 1. Base and Mobile Framework

The base and mobile framework 302 is the foundation layer of the home care administration system 100 and allows modules 304 through 322 to operate. Framework 302 could include, for example, an application programming interface (API) that may be used in conjunction with the various modules. Additionally (or alternatively), the framework 302 could include program instructions to help facilitate the various module functions. For example, framework 302 could execute as a standalone server to coordinate functionality of the various modules, and/or framework 302 could execute as a library that is part of another standalone server, such as a Java Enterprise Edition-based application server.

Framework 302 may integrate disparate application and data solutions that may make up one or more of the modules, each of which may run on one or more different server computers. Framework 302 may provide this integration by facilitating communication between the various modules and communication devices in communication with server system 104. Such communication may occur using eXtensible Markup Language (XML) (perhaps via the simple object access protocol (SOAP) protocol) and/or the Java message service (JMS), among other possibilities. Communication between the various modules and communication devices may also be encrypted, perhaps using internet protocol security (IPsec), secure sockets layer (SSL), transport layer security (TLS), or hypertext transfer protocol secure (HTTPS), for example.

Framework 302 may provide the various entities in system 100 with a single point of access to one or more modules. The framework could provide, for example, a web-based interface or “dashboard” that could be used by supervisors to manage visits via a web browser (perhaps running on a computer or a mobile device), and/or by caregivers to send or receive visit information. The framework could additionally or alternatively provide an interactive voice response (IVR)/telephony interface to allow a caregiver and/or supervisor to send or receive visit information. As still another example, framework 302 could provide an interface that would allow an application executing on communication device 101 to communicate with server system 104. Further, the framework could provide these interfaces in conjunction with one or more modules. For example, framework 302 could work in conjunction with IVR/telephony module 322 to provide the interactive-voice-response features described herein.

Note, however, that the various modules could additionally or alternatively be accessed without framework 302. For example, while billing/accounting system 122 may allow communication device 101 and display/terminal 116 to access billing information via framework 302, the billing system could also allow such devices to interact with the system directly, without the framework.

Based on the framework 302, applications in the system 100 are designed and tuned to provide optimal performance in the mobile home care and home health settings. For example, the framework includes, but is not limited to, components such as dynamically rendering data collection forms for communication device 101; dynamically rendering applications from the server system 104 to communication device 101; and managing data types, rules, validation, offline data storage, security, and data and/or voice transmission between the communication device 101 and the server system 104.

For example, dynamic rendering of data collection forms on communication device 101 may include the presentation on the communication device of a particular electronic fillable medical form and/or voice-prompted medical form to be filled out by a caregiver during a patient visit. In legacy systems, such as paper-based systems, forms were often designed to look and be used the same way regardless of what tasks were to be performed for a particular visit, in order to promote uniformity and prevent mistakes in complying with standards set by Medicare and other organizations. However, the framework 302 may provide a patient-specific, visit-specific form for each visit to a patient. Framework 302 may allow server system 104 to provide an indication of this content to communication device 101, so that the communication device may present a form that includes only the patient-specific, visit-specific tasks to be performed.

At least two possible techniques for presenting forms via communication device 101 vary in the amount of processing performed by the communication device versus the server system 104. A first technique is for the server system 104 (and, in particular, an application on the application server 114) to send task metadata to communication device 101. The task metadata could indicate, for example what specific tasks are to be performed and the kind of data expected to be entered in response to performing those tasks (e.g. numbers, characters, integers, binary inputs, or even particular expected ranges, such as a range for body temperature or blood pressure). A second technique would be for the server system 104 to create the form on the server side and send the created form as a fillable patient-specific, visit-specific form to communication device 101. The communication device 101 would then present the fillable form, perhaps using a display and/or a speaker, and accept data entries from the caregiver. The decision of whether to use the first technique or the second technique, or a variation of either one, will depend on several factors, such as the bandwidth of the transmission media (e.g., communication paths 110 through 113), the processing capabilities of communication device 101, and other factors. The presently preferred embodiment utilizes the first technique to account for relatively slow transmission rates supported by many current cell phone systems. The term “fillable form” is intended to broadly encompass text prompts, a graphical form, audio prompts, and other forms for collecting data.

Dynamic rendering of applications from the server system 104 to communication devices 101 allows application(s) on the communication devices to be updated and/or supplemented without frequent recompilations. By specifying, through use of the server system 104, client or company specific requirements, (such as graphical menus, layouts, widgets, and data) a mobile application may be built or rendered on the fly. The server sends the actual application as well as the metadata concerning the visit-specific form.

Managing data types, rules, validation, offline data storage, security, and data transmission are other tasks that are preferably handled by the framework 302.

Since the system 100 is designed to present the caregiver with fillable patient-specific, visit-specific forms, it becomes beneficial to assess the data being entered by the caregiver into such forms. By sending metadata to communication device 101, the server system 104 can provide instructions on how the application on the communication device treats data and what kind of data is expected (e.g. a particular range for a blood pressure reading). Expected data types may include, for example, number, character, integer, binary value, etc. In addition, the metadata might also include one or more rules for at least some of the data entries made by the caregiver. An example of a rule is that an entered pulse rate cannot equal zero or a negative number. Finally, to ensure that the entered data matches the expected data, validation can be performed to check the entered data values against the rules. Such validation could also occur at the server system 104, or perhaps some other entity in communication with the server system and/or communication device 101.

Offline data storage may be necessary in at least two cases: (1) while communication device 101 is not able to communicate with server system 104 (for example, while the communication device is out of wireless data service coverage), so that the data needs to be stored until communication is possible again, and (2) when data has just been collected and entered into communication device 101, but not yet transmitted to the server system 104. Such offline data storage is preferably in memory or some other storage medium that maintains its contents even if the communication device 101 is powered down.

Security may include at least two aspects. A first aspect is directed to assessing whether the possessor/user of communication device 101 is authorized to access the communication device, and/or to communicate with server system 104. This assessment could include requiring the user to enter a PIN (Personal Identification Number) or username and password, for example, when communication device 101 is turned on, when communication device 101 initiates a connection with server system 104, or when a home care application is started up on communication device 101. This is to prevent an unauthorized user from accessing (1) applications pertaining to the system 100, (2) offline data that may be stored on communication device 101, and/or (3) data that may be stored on server system 104. Such offline data could include, for example, clinical patient measurements that have been stored offline (on communication device 101) while communication device 101 is unable to communicate with server system 104, or even data that has just been collected and entered into communication device 101, but not yet transmitted to the server system 104. The second aspect is directed to protecting data as it is communicated across communication links 110/112 and/or 111/113. The second aspect may be addressed by encrypting the data and deleting offline data from communication device 101 once it has been sent to the server system 104.

### 2. Point-of-Care Caregiver Scheduling Module

The point-of-care caregiver scheduling module (“scheduling module”) 304 enables the home care office and caregivers to dynamically create, publish (provide appropriate notification), and synchronize schedules bi-directionally in real-time, while caregivers are in the field. There are two aspects to these scheduling functions. First, as opposed to being only static, the scheduling module 304 allows a caregiver's schedule to change while the caregiver is in the field (e.g. conducting a visit at a patient's home). For example, while a first caregiver is conducting a visit at a first patient's home, the home office might receive notice that a second caregiver has become ill and will be unable to complete his or her previously scheduled visits. The home office can then update the first caregiver's schedule so that the first caregiver can cover the visits that the second caregiver was previously going to conduct. The first caregiver will then receive notification of the updated schedule and can go to the next patient's home accordingly. As another example, caregiver schedules might be changed if a worker at the home office notices that several visits are in a particular area or location (e.g. at a single nursing home), so that it would be more economical and efficient for a single caregiver to conduct all the visits for that data at that particular location. A second aspect to the scheduling functions handled by the scheduling module is its bidirectional nature. Workers in the field (e.g. caregivers) are able to set schedules according to predefined rules. For example, if this functionality is present and enabled, a higher-skilled worker (e.g. nurse) might set the schedule of a lower-skilled worker (e.g. nurse's aide), either directly or by updating his or her own schedule. If a nurse updates her schedule to conduct a wound-inspection visit with a burn victim, such an update might also include updating the schedule of a nurse's aide to visit the same patient at the same time or directly after, to apply new bandages, for example.

In a preferred embodiment, the point-of-care caregiver scheduling module acts as a workforce management system that generates work schedules dynamically based on a plurality of worker-based variables, patient-based variables, or other variables. Example worker-based variables include (1) a worker's location, (2) a worker's expertise level, and/or (3) whether a worker has previously conducted a visit at a particular location. Example patient-based variables include (1) a patient's location, (2) a patient's care plan or medical plan status (e.g. covered services/timing versus non-covered services/timing), and/or (3) a patient's disease-state or condition. The workforce management system may be particularly beneficial where an appointment is cancelled and a worker needs to be efficiently rescheduled, in emergency situations, where a worker needs to be rescheduled because of a change in a patient's disease-state or condition, or in the situation where a patient's insurance coverage would expire after a certain date so that a visit should be conducted before expiration.

The aforementioned workforce management system preferably interfaces with the GPS tracking and travel management module to obtain worker location information. Patient information, such as location information, may be obtained from home office records (such as a patient database), for example. Dynamic generation of schedule information based on location information may be accomplished by selecting visits in order to minimize a travel-route cumulative distance, as determined by accessing maps databases, such as those offered by NAVTEQ or Tele Atlas NV, for example.

### 3. Electronic Visit Record and Care Plan Module

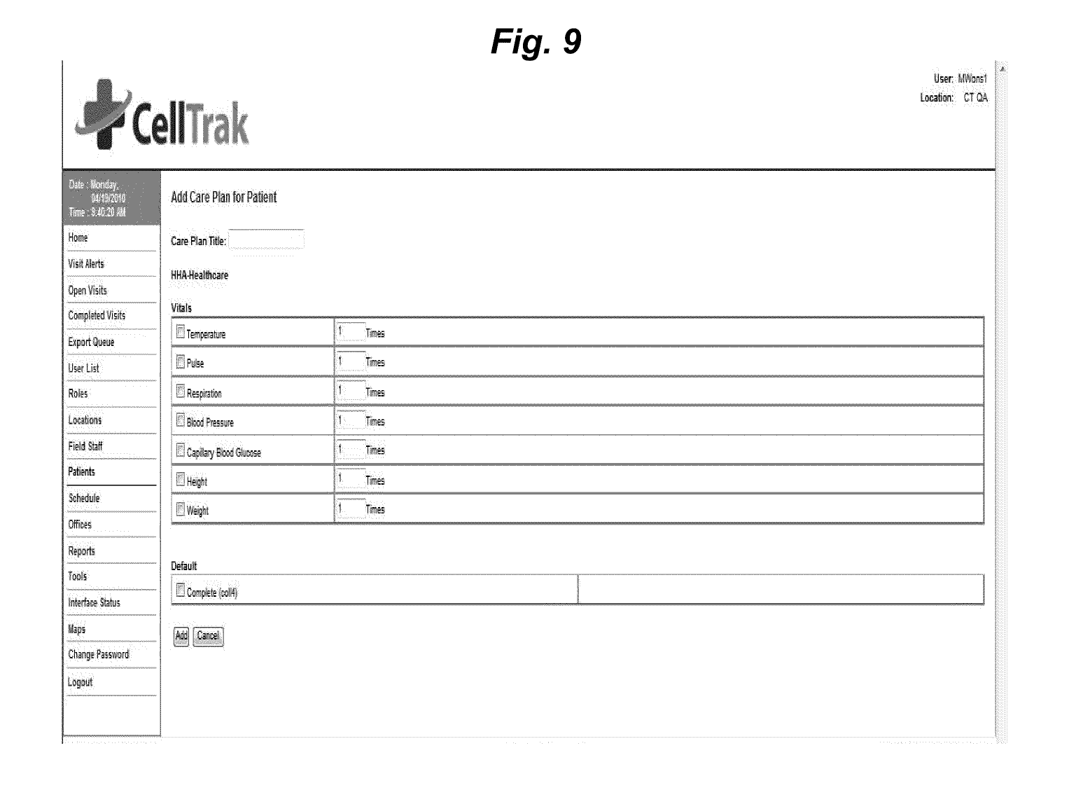

The electronic visit record and care plan module 306 preferably comprises software applications located on communication device 101 and/or at the server system 104 (such as on the server computer 114) for creating, storing, communicating, and monitoring information on patients, visits, tasks, care plans, and other home-care-related information. Legacy systems typically were paper-driven and labor intensive, due to the prevalence of paper forms that were generic, rather than patient-specific and/or visit-specific. In contrast, the electronic visit record and care plan module 306 provides customizable care plans that may be presented in real-time to communication device 101. Customization may include, for example, the ability to add tasks to a visit “on-the-fly,” such as throughout a particular patient's overall home care period, as the patient's condition improves, declines, or otherwise changes. In addition, different tasks can be added by different supervisory care persons, such as nurses, doctors, or therapists, to be performed by the caregiver in the field. Such care plan customization may be accomplished, for example by presenting a care plan administrator with a user interface identifying a plurality of tasks that can be selected, such as through check-boxes that the administrator may select. (See FIG. 9.)

When used in conjunction with the scheduling module or a variation thereof, the electronic visit record and care plan module 306 can be utilized to deliver the patient-specific, visit-specific care plan to the correct caregiver at the correct time and place (such as when the caregiver is arriving at the patient's home). When used in conjunction with the GPS module 308 (described below), the electronic visit record and care plan module 306 may receive a notification that the caregiver's location is close to or the same as the patient's location, which can serve as a “transmit initiation” signal indicating that that particular patient's care plan should be sent out to the caregiver at that location (as determined by the GPS module 306) (i.e. “pushed” by the server system 104 to communication device 101). In embodiments lacking the GPS module 306, the caregiver may simply enter a patient ID to cause that patient's care plan to be transmitted (i.e. “pulled from the server system 104”). Alternatively, the care plan for a particular patient may be transmitted at a particular time, as maintained by the scheduling module 304 (i.e. “pushed” by the server system 104 to the mobile application device 102).

The frequency of data transmissions will depend on the particular activity that is in process; however, a typical schedule might be a morning download to obtain schedule information, along with periodic transmissions as visits are completed. For example, a home infusion therapy visit might call for relatively infrequent transmissions (e.g. batch files transmitted three times per day), since an infusion is generally a slow process, with relatively little data to report. In contrast, a battery of clinical measurements performed by a nurse's aide may be transmitted after each measurement is taken, for real-time reporting, which can be useful if disease management intelligence is included in the system (see FIG. 3, module 316).

In addition, the electronic visit record and care plan module 306 helps to ensure that the visit record (the data entered by the caregiver into the fillable form or the filled form itself) matches the individualized care plan. As a result, no extra tasks are performed (saving time and expense) and no tasks are omitted without reason (promoting the patient's well-being and saving extra expenses associated with extra patient visits to complete omitted tasks). This also helps to ensure compliance with organizations and packages requiring standardized formats, such as those reporting records required by Medicare and other reimbursing organizations. Service codes and billing exceptions and required records (e.g. HHA records) can be generated automatically.

Another function that can be performed by the electronic visit record and care plan module 306 is to validate data entered by the caregiver. Validation is basically comparing the collected (entered) data with built-in user-defined business intelligence and/or rules that can be specified by a user, such as a home care administrator or health care professional. An example of business intelligence is an allowable range for a blood pressure reading. Thus, when a high blood pressure reading is taken, the caregiver may be instructed by the application via communication device 101 (or through messaging from the server system 104) to call a particular nurse or to give patient-specific health and wellness instructions. Thus, while the data may technically be the correct type of data (e.g. an integer) as called for by a particular rule, it may still be acted upon by the business intelligence to generate an alarm condition (e.g. call nurse). Rules and business intelligence can be communicated by metadata, as discussed above with reference to the base and mobile framework 302.

Yet another function that may be supported by the electronic visit record and care plan module 306 is to interact with telemedicine devices. A telemedicine device may take and/or record measurements from a patient and either (1) transmit those measurements in real-time to the mobile device application 102 or (2) store measurements until a certain condition is satisfied, such as a caregiver visit is taking place, before transmitting (non-real-time). A PAN (Personal Area Network) technology, such as Bluetooth, may be used for communications between the telemedicine device and communication device 101. Examples of such possible devices are scales, pacemakers, and blood pressure monitors, among others.

Finally, the electronic visit record and care plan module 306 can be used to assign or attach multiple care plans to a single patient. In a sophisticated home care system, a single patient may have more than one caregiver. For example, an elderly patient being treated at home for a fractured hip caused by a recent fall may be visited by both a nurse and a physical therapist, both of which are likely to provide different types of care. These different care types can manifest themselves through two different care plans comprising different sets of tasks selected to be performed by the caregiver.

### 4. GPS Tracking and Travel Management Module

The GPS tracking and travel management module (“GPS module”) 308 can be included in various embodiments of the invention to assist in tracking home care providers, presenting actual driving mileage traveled by a caregiver along with a shortest route indication and shortest mileage, tracking actual visit times, and alerting missing or delayed visits as exceptions. Even though the examples provided below with regard to the GPS module are described with reference to mobile application device 102, those having skill in the art will recognize that the GPS module could also be used with POTS device 103, among other possibilities.

In order to offer GPS-module functionality, the mobile application device 102 is preferably equipped with a mechanism for determining its current location, such as a GPS receiver. Many cell phones manufactured today and in recent years include a GPS receiver in them, which can be used for this purpose. Additionally or alternatively, another device communicatively connected to mobile application device 102 could provide GPS functionality to the mobile device, perhaps by sending location information to the mobile device. By transmitting the current location of the mobile application device 102 (based on an output from the GPS receiver) to the server system 104, the server system 104 will have information pertaining to the current location of caregivers in the field, assuming each caregiver has an associated mobile application device 102.

To provide the home office with information for tracking caregivers, GPS position updates could be periodic, such as every 10 seconds, or based on change in location, such as whenever the GPS coordinates indicate a change in location of more than one kilometer, for example. Other location updating schemes could also be used and are intended to be within the scope of the present invention. In a preferred embodiment, the location-updating period may depend on the schedule maintained by the scheduling module 304, so that if a caregiver is at lunch or on vacation, no GPS updates are transmitted.

An advantage of tracking location of mobile caregivers is that actual driving mileage can be obtained from the transmitted location information. This can help to lessen or eliminate the need for caregivers to manually record their mileage and can help to reduce mileage reimbursement costs for a home care entity. According to one embodiment, the system 100 can also determine a shortest path by including an application on the server computer 114 that can access a map database (such as one produced by NAVTEQ or Tele Atlas NV) that associates roads and other geographic features with coordinates, such as the latitude-longitude information included in a GPS signal. By utilizing known routing software to find a shortest path between an origin and a destination, the server computer 114 can determine the shortest path and compare it, if desired, to the path taken by the caregiver.

Another advantage provided by tracking caregiver location is the ability to identify potential problems, such as when a caregiver is likely to be late for a scheduled visit, based on the current location of the caregiver (as determined from the location of the mobile application device 102), the distance to the patient's location, and possibly other information, such as the average or maximum posted speeds for the roads on the shortest path and/or traffic information, from a traffic provider, such as Traffic.com or others. Another exception that can be identified by tracking caregiver location is detecting that a scheduled event never occurred, such as due to the caregiver forgetting or misreading a schedule, for example. This can, in turn, improve customer service should the patient contact the home office regarding the missed visit.

In an alternative embodiment, GPS functionality is partly or completely replaced and/or supplemented by RFID (Radio Frequency Identification) technology for tracking a caregiver's location. This may be particularly useful in a location such as a nursing home or assisted living center, where one or more RFID receivers can be located throughout a facility to track caregivers wearing or carrying coded RFID transmitters. The RFID receivers can then transmit caregiver location and time information to the server system 104 for tracking purposes. Other RFID implementations are also possible, such as RFID triangulation techniques using several RFID receivers for more precise positioning.

Finally, the GPS and travel management module 308 can help home care staff plan optimized patient visit times depending on the optimized route planning For example, a home care administrator may need to plan a caregiver schedule for five patient visits during a particular day. The GPS and travel management module 308 can intelligently calculate the most economic visit sequence based on a combination of factors including, without limitation, patient location, visit duration, pre-scheduled patients, visit starting location (staff home or home care office), visit ending location (staff home or home care office), and places required to be visited during the day (e.g. physician office or laboratory). In this embodiment, the GPS tracking and travel management module preferably integrates with the workforce management system described above, with respect to the point-of-care caregiver scheduling module.

### 5. Clinical Messaging and Notification Module

The clinical messaging and notification module 310 allows for real-time asynchronous communications, as broadcasts, multicasts, or unicasts, depending on the nature of the message to be delivered and its intended recipient list. While typically these may be initiated from the home office for announcements and other purposes, they may also be initiated from communication device 101, and then related to others via the server system 104. An SMS text message delivered to a cell phone is one example of how messaging may be made from the server system 104 to communication device 101.

An example of how the clinical messaging and notification module 310 might be used is if there were an epidemic, in which it suddenly became critical to notify all caregivers immediately of the situation so that appropriate action and precautions could be taken. Another example is a simple notification that paychecks are ready for pickup at the home office.

### 6. Surgical and Wound Care Management Module

The surgical and wound care management module 312 allows patient surgical and wound conditions to be captured as clinical images for remote clinical observation. These images can be transmitted in real-time from the filed to the home office and/or from aides to skilled nurses to ensure that appropriate assessment and care are provided to the patient.

The clinical images may be captured by a camera or video camera in communication device 101. Alternatively or additionally, the images may be captured by a separate device (such as a digital camera) and transferred to communication device 101, perhaps via a Bluetooth connection or via a physical memory card transfer. Those having skill in the art will recognize that other arrangements are possible as well without departing from the scope of the claims. In some embodiments, the caregiver in the field provides a voice annotation that can be associated with the image data, such as to indicate the anatomical location of the images or other observations, such as unexpected odors, etc.

The surgical and wound care management module 312 addresses a possible shortcoming that faces the home care industry—the relative lack of patient observation by a skilled practitioner as compared to an in-patient. Of the approximately 42 million people that undergo surgical operations in the United States each year, approximately 40% of the procedures are accompanied by post-operative complications, such as infections, thrombo-embolic events, respiratory complications, and adverse cardiac outcomes. The surgical and wound care management module 312 provides a mechanism for providing clinical observation without the negative consequences associated with a prolonged hospital stay.

### 7. Supply Order Fulfillment Module

The supply order fulfillment module 314 addresses a common inefficiency observed in typical, traditional home care practices—ordering supplies needed in the field. This module enables a mobile caregiver to place supply order requests via communication device 101 at the point of need (the patient's home or other location). The supply order requests are transmitted to the server system 104, where they can be aggregated at an application on the server computer 114 for order fulfillment.

### 8. Disease Management Intelligence Module

The disease management intelligence module 316 can provide caregivers with information and reminders regarding their patients' health conditions, which may be particularly useful in post-discharge settings. The server system 104 can maintain a database of clinical contents and rules, then send out messages and/or alerts (e.g. through SMS messages to the mobile application device 102), based on data sent by the caregiver from communication device 101 to the server system 104. For example, a caregiver, upon transmitting a patient's heart rate from communication device 101 to the server system 104, might receive a message or prompt from the disease management intelligence module 316 on the server computer 114 indicating that the measured heart rate is higher than a predetermined threshold and that the caregiver should remind the patient to take a recommended dosage of a prescribed medicine, in order to assist in reducing the patient's heart rate. Generally, the disease management intelligence module 316 is an application on the server computer 114 that applies a set of clinical contents and rules to data received from the caregiver and transmits alerts and or recommendations if the received data meets an alert condition. In a preferred embodiment, the clinical contents and rules are abstracted from one or more evidence-based medical resources. Alternatively, the clinical contents and rules may be manually entered, such as by a home office staff person or health care professional.

### 9. Administrative Center Module

The administrative center module 318 is preferably a portal on the server computer 114 that allows home care administrators and office staff to manage a home care business operating the home care administration system 100. In a preferred embodiment, the portal is a web-based portal offering anytime/anywhere information access, so that the business can be managed virtually. This promotes telecommuting and will generally tend to reduce timelines associated with scheduling, approving, and submitting invoices for payment. This, in turn, can shorten accounts-receivables timelines, which will typically be a financial benefit for the home care business. While the system 100 is pictured as having a single server computer 114 to act as a web portal, there may instead be multiple server computers 114 at a single location (for load balancing and redundancy, for example), or there may alternatively be different server computers 114 affiliated with regional or local home care offices and having different web addresses from one another.

One function support by the administrative center module 318 is managing users of the system 100. A home care administrator and/or office staff person can add, delete, and/or edit users of the system, such as caregivers and others. In addition, other properties associated with each user may be defined, such as roles, permission levels, and authority hierarchies, for example. The administrative center module 318 residing on the server computer 114 provides for numerous roles that assign different rights to users communicating with the server computer 114.

A second function relates to tasks that may be performed by a caregiver for a particular function. While the electronic visit record and care plan module 306 is the primary module for defining a care plan comprised of tasks, the administrative center module 318 can serve as the interface for selecting, defining, and modifying tasks to be performed. Correspondence between tasks in the system 100 and tasks supported by outside reimbursement agencies (e.g. Medicare) can also be determined at the administrative center module 318.

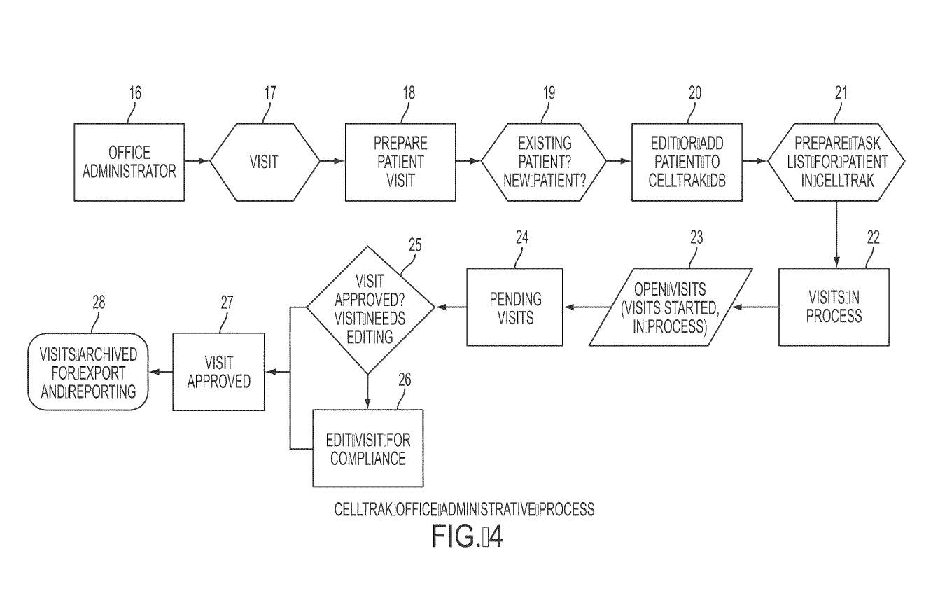

Another function of the administrative center module 318 is to manage visits. In a preferred embodiment of the invention, six visit types are defined: scheduled visit, open visit, pending visit, approved visit, denied visit, and archived visit. Each of these will now be summarized in turn. Additional details are set forth with respect to FIG. 4 and its accompanying description.

A scheduled visit is a visit that has a care plan associated with it and that has been scheduled to be performed by a caregiver. An office administrator (admin) or an appropriate delegate may be responsible for setting the daily tasks for the caregiver. This includes creating, reviewing, and editing task lists that the caregiver is to perform during a visit to a patient's home. The admin prepares the patient visits, for example, by using the administrative center module 318 on the server computer 114. After a patient is entered (or already exists) on the server computer 114, the admin creates or edits an individualized patient task list by checking which tasks an agent is to perform during a visit. The admin saves patient information for storage at the server computer 114. In one example, the admin adds or edits patient information for database storage associated with the server computer 114. Information such as the patient's name, address, latitude-longitude information, patient medical record number(s), location (servicing home-care office), and a corresponding task list may be entered manually. Alternatively, the administrative center module 318 provides a method to import patient information using one or more techniques (discussed in further detail with respect to FIG. 4). After the appropriate patient information is entered in the administrative center module 318, the admin creates or edits a patient task list by checking which tasks an agent is to perform during one or more visits. The admin saves the patient information for storage in memory.

An open visit is a visit that is being performed by a caregiver or other person in the field. Visits can thus be monitored as they happen. Caregivers perform visits using communication device 101. The admin is able to view visits that have been started by a caregiver in real time. The visit can also be deleted should the visit be abandoned accidentally. The server computer 114 can display a visit in at least four different views, according to one embodiment: open, pending, approved, and history. When a visit is in the open state an application on the server computer 114 will query a database, such as a MySQL database, for all appropriate open visits, such as open visits tied to the location to which the admin account is linked in a customer_accounts table. The resulting visits list is displayed on the server computer 114 under an “open visits” field. If the role assigned to the admin account has all “open visit” permissions then the admin account will be able to delete, complete, or view that open visit. A “delete visit” function will completely remove the visit and related visit tasks from the database. A “complete open visit” function will update the visit status from “open” to “pending”. A “view visit” function will display the visit information that includes the visit tasks.

A pending visit is a visit that has been completed by a caregiver (or other person in the field) that has not yet been “approved.” When a caregiver completes a visit, the admin is able to view the caregiver's finished visit in the “pending visit” section of the administrative center module 318. The admin can also edit the pending visit to ensure completeness of visit information. This allows the admin to ensure all visit data is correct, and also allows the admin to make corrections. This ensures that the visit meets compliance. The visit can also be deleted should the visit not meet completeness or compliance. This allows the agent to be re-scheduled, if desired. When a visit is in the “pending” state, the administrative center module 318 will query a database, such as the MySQL database described above, for all pending visits tied to the admin's location, such as the location to which the admin account is linked in the customer_accounts table described above. The resulting visits list will be displayed on the server computer 114 under “pending visits.” If the role assigned to the admin account has all pending visit permissions then the admin will be able to delete, move to “approved,” view, or move-all to “approved.” The “delete visit” function will completely remove the visit and related visit tasks from the database. The “move to approved visit” function will update a single visit's status from “pending” to “approved.” The “view visit” function will display the visit information that includes the visit tasks, in an html form (or another convenient format) that enables the admin to make changes to the visit information to ensure data integrity. The “move all to approved” function allows the admin to move all “pending” visits and allows the admin to update the status of all the listed visits to “approved” status.

An approved visit is a visit that has approved by the admin. The admin is able to determine if a visit is completed properly using the “pending visit” functionality described above. In the presently described embodiment, once the admin moves a visit to “approved visit” status, that visit can no longer be edited or deleted.

A denied visit is a visit that has been denied by the admin. The admin is able to determine if a visit has not been completed properly using the “pending visit” functionality described above. In the presently described embodiment, when the admin moves a visit to “denied visit” status, that visit can be edited for accuracy and completeness and then moved to “approved visit” status, if appropriate.

An archived visit is a visit that has previously been approved and is to be saved for record-keeping purposes. The admin selects visits in the “visit approved” section for archiving. The admin may select individual visits, all visits, or a subset of all visits. Once a visit is moved to “archive,” that visit is no longer active. The “move to archive” function places the visit into a holding area, where the visit information can be exported manually through the administrative center module 318, or automatically via the methods mentioned in reference to FIG. 4. Visit information preferably remains in an archived state within the administrative center module 318 indefinitely. This allows for future reporting on all visit information.

### 10. Enterprise Application Integration Module

The enterprise application integration module 320 may be included in the system 100 if the system 100 will be integrated with applications from third parties. The enterprise application integration module 320 includes application components that are designed to communicate with other home care systems and has features to support multiple communication protocols, including, without limitation, HTTP, FTP, and Secure FTP. Possible data structures that may be embodied in such communication protocols include HL7, XML, CSV, and other formats. The module is flexible to support real-time communication and file batch communication. The enterprise application integration module 320 also includes a data mapping utility that maps incoming data messages from the third party format into its own data format that the database server 120 supports.

For example, the billing/accounting system 122 shown in FIG. 1 may be a third-party application. The enterprise application integration module 320 would allow that third-party application to integrate and interoperate with applications on the server computer 114 and/or the database server 120, for example. This may enable administrators and/or other home office staff to view integrated and complementary views of financial and billing information. Other third-party applications that might be partly or entirely integrated into the system 100 using the enterprise application integration module 320 are a scheduling and/or payroll system, a clinical medicine database application, Medicare compliance applications, and others. The information exchanged between the enterprise application integration module 320 and third-party applications may be exchanged in real-time or near real-time, for example.

Referring to FIG. 3a, steps related to the application programming associated with the mobile application device 102 are provided and shown, according to a preferred embodiment. Part of the processing related to the system 100 is software that is targeted to communication device 101 (i.e., the “client”). When an agent, such as a caregiver, enters a home, the agent launches this specified application, which begins the following process shown in steps 1-15 of FIG. 3a.

In step 1, FIG. 3a, the agent is first prompted to enter characters identifying the agent and patient. With this data, the client software attempts to make contact with the server computer 114, via an HTTP communication protocol in step 2, FIG. 3a. Upon successful communication between the client mobile application device 102 and server computer 114 in step 4, the server computer 114 is able to provide the client mobile application device 102 with the tasks that are associated with the patient. This indicates the creation of a “visit,” along with tasks that are associated. In step 3, the client mobile application device 102 requests task data from the server computer 114. The server computer 114 then provides this information to the client mobile application device 102, via an HTTP response as seen in step 6, FIG. 3a.

If communication cannot be established between the server computer 114 and client mobile application device 102 as seen in step 4, the client mobile application device 102 falls into a failsafe mode, which prompts the user to select which tasks he or she is to perform with this patient from a predetermined list, step 5, FIG. 3a. Once the agent has a selection of tasks that are generated by the user/agent (step 7, FIG. 3a), the client mobile application device 102 then allows the agent to report the states of these tasks. The “states” are indicators of the outcome of performance for the task. Examples include, but are not limited to: the task was completed as required, the patient refused to have the task performed, etc. These task states might have data associated with them. Examples would be a numerical number to indicate: the patient's temperature, the patient's pulse rate, etc. The application on the client mobile application device 102 provides an interface which collects this data from in the user/agent as seen in step 8, FIG. 3a.

When the agent has finished entering required data at step 9, FIG. 3a, the client application then performs a series of validations on the data, to make certain that the state of each task has been reported. Once the data has been verified to be correct, the application on the client mobile application device 102 prepares the data for transmission, in step 10, FIG. 3a. If the data is stored, in step 11, the stored data is prepared for transmission. In step 12, FIG. 3a, a determination is made as to whether stored data is present. If it is, processing proceeds to step 11. If the stored data is not present, then the processing moves to step 14, FIG. 3a, to determine if the server computer 114 can be reached. If a contact attempt is successful, the client mobile application device 102 transmits the data to the server computer 114, which is recorded and stored at the server system 104, such as at the database server 120, as seen in step 13, FIG. 3a.

If however the contact attempt fails to reach the server computer 114 in step 14, the application on the mobile application device 102 will store the data associated with the visit onto the data repository of the mobile application device 102, as shown in step 15, FIG. 3a. This data will be held until such time that the mobile application device 102 makes a successful connection with the server computer 114 with a future visit. If the application on the mobile application device 102 detects that it has stored data from previous failed transmissions, this data is prepared for transmission on each subsequent data transmission attempt as seen in step 10, FIG. 3a.

Note that the steps depicted in FIG. 3a could be carried out by a communication device that does not contain a processor and/or memory, or an ability to communicate using HTTP. For example, using framework 302, server computer 114 could employ communication device 101 to present audio prompts to the caregiver and receive inputs from the caregiver (perhaps dual-tone multi-frequency signaling (DTMF) inputs or pulse dialing inputs over POTS).

Referring now to FIG. 4, a flowchart diagram illustrating steps performed in association with application server 114 of the server system 104 is shown. In this embodiment, the application server functions as a web portal server computer. In block 16, FIG. 4, an office administrator (admin) refers to employees at the local office (Location) level, responsible for setting the daily tasks for the field personnel agent (such as a home healthcare service staff member or caregiver). This includes creating, reviewing and editing task lists that the agent is to perform during a visit to the home of the patient(s). Visits are monitored as they happen (Open Visits). This further entails reviewing and editing, if necessary, visits that have been completed by the agent (Pending Visits) and approving visits (Approved Visit). The web application residing on the server computer 114 provides for numerous roles that assign different rights to users communicating with the server computer 114. The admin also has the responsibility of adding other office users into the web portal computer application and assigning these roles to the appropriate users.

In block 17, FIG. 4, “visit” is terminology used in the web portal computer application to describe the activity of an agent operating communication device 101 in the field. The agent, for example, is responsible for visiting patients in their homes, nursing homes, hospitals, or wherever a patient may be located. The web portal computer application tracks these visits through the entire visit cycle as the communication device of the agent is used.

In block 18, FIG. 4, the admin prepares for patient visits using the web portal computer application. In block 19, FIG. 4, the admin checks to see if information exists in the web portal computer application. After a patient is entered in the web portal computer application, in block 20, FIG. 4, the admin creates or edits a patient task list by checking which tasks an agent is to perform during a visit. The admin saves patient information for storage at the web portal computer.

In one example, the admin adds or edits patient information for database storage associated with the web portal computer. The web portal computer application provides a method to enter patient information manually, including, but not limited to:

Patient name

Patient address

Latitude and longitude information

Patient Medical Record Number(s)

Location (Office responsible for patient)

Task List(s)

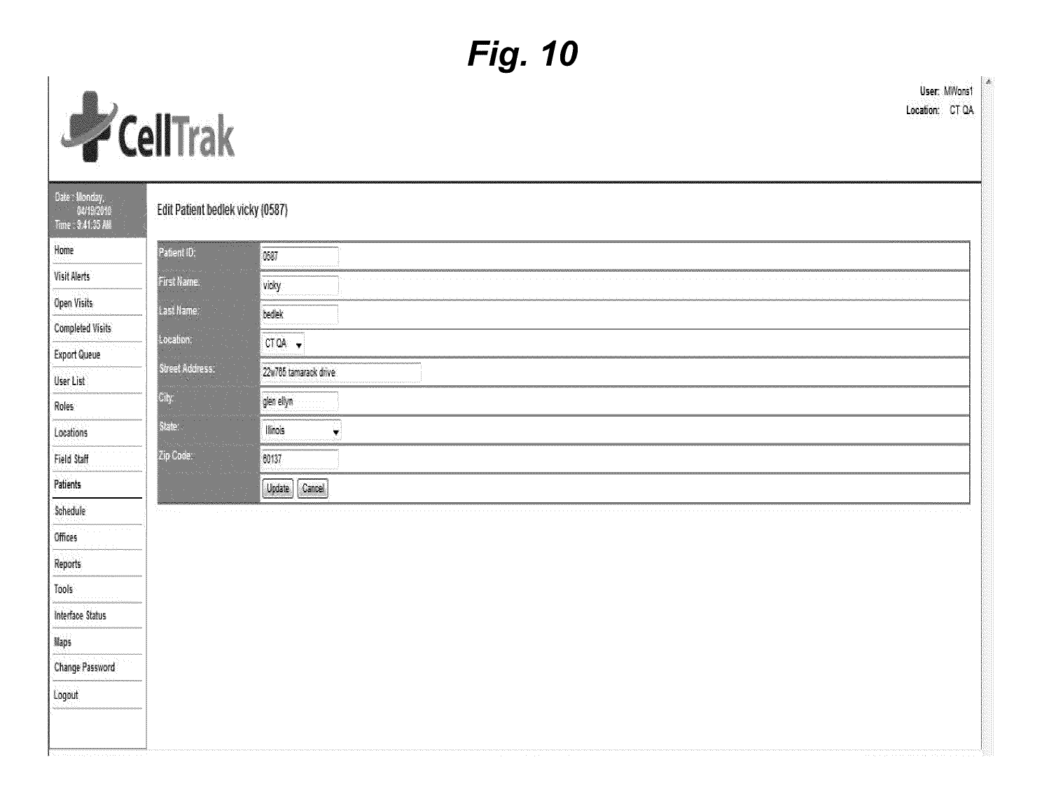

(See FIG. 10.) Alternatively, the web portal computer application provides a method to import patient information using the following methods, without limitation:

Remote via SFTP

Remote via HTTPS

Local via TCP/IP

Formats, csv, xls, dbf, XML, or database connection

After the appropriate patient information is entered in the server computer 114, in block 21, FIG. 4, the admin creates or edits a patient task list by checking which tasks an agent is to perform during one or more visits (see FIG. 9). The admin saves the patient information for storage in memory or other data storage, such as the database server 120. In block 21, visits in process take place. The agents may perform visits using communication device 101, perhaps operating under the software program application as described in FIG. 3a, and/or operating over POTS, among other possibilities.

Block 23 refers to Open Visits. The admin is able to view visits that have been started by an agent in real time. The visit can also be deleted should the visit be abandoned accidentally. The web portal server computer 114 can display a visit in at least four different views: Open, Pending, Approved, and History. When a visit is in the open state the web computer application will query a database for all open visits tied to the location that the admin account is linked to in a customer_accounts table. The resulting visits list is displayed in the server computer 114 under “open visits.” If the role assigned to the admin account has all open visit permissions then the admin account will be able to delete, complete, or view that open visit. A “delete visit” function will completely remove the visit and related visit tasks from the database. A “complete open visit” function will update the visit status from “open” to “pending”. A “view visit” function will display the visit information that includes the visit tasks.

Block 24, FIG. 4, relates to Pending Visits. When an agent completes a visit, the admin is able to view the agent's finished visit in the Pending Visit section of the web portal computer application. The admin can also edit the pending visit to ensure completeness of visit information. This allows the admin to ensure all visit data is correct, and also allows the admin to make corrections. This ensures that the visit meets compliance. The visit can also be deleted should the visit not meet completeness or compliance. This allows the agent to be re-scheduled. When a visit is in the pending state the web computer application will query the database for all pending visits tied to the location that the admin account is linked to in the customer_accounts table. The resulting visits list will be displayed in the web portal server computer 114 under pending visits. If the role assigned to the admin account has all pending visit permissions then the admin will be able to delete, move to approved, view, or move all to approved. The “delete visit” function will completely remove the visit and related visit tasks from the database. The “move to approved visit” function will update a single visit's status from “pending” to “approved”. The “view visit” function will display the visit information that includes the visit tasks, in an html form that enables the admin to make changes to the visit information for data integrity. The “move all to approved” function allows the admin to move all pending visits and will allow the admin to update the status of all the listed visits to “approved” status.

Block 25, FIG. 4, relates to visit approval, so that a determination is made as to whether the visit is approved or needs editing. The admin is able to determine if a visit is completed properly using “Pending Visit”. If the Visit is complete, the visit can be moved to next stage. Block 26, FIG. 4, relates to “Edit Visit for Compliance”. If the visit is not complete, it can be edited for completeness and then moved to the next stage, “Visit Approved” (block 27). When the admin moves a visit to this stage, the visit can no longer be edited or deleted.

Block 27, FIG. 4, relates to visits approved and visits archived. The admin selects visits in the “visit approved” section for Archiving. The admin may select individual visits, or select all visits. Once a visit is moved to Archive, the visit is no longer active. The “move to Archive” function places the visit into a holding area, where the visit information can be exported manually through the web portal computer application, or automatically via the methods mentioned in relation to block 13. Visit information remains in an archived state within the web portal computer application indefinitely. This allows for future reporting on all visit information.

Block 28, FIG. 4, relates to visits archived for export and reporting. When a visit is in the approved state, the web application will query the database for all approved visits tied to the location that the admin account is linked to in the customer_accounts table. The resulting visits list will be displayed in the web portal under “approved visits”. If the role assigned to the admin account has all approved visit permissions, then the admin account will be able to move all to history, move to history, or view approved visits. The “move all to history” function will move the database entry from the “visits” table to the “history visits” table and it will move the visit tasks from the “tasks” table to the “history tasks” table for all approved visits displayed. The “view visit” function will display the visit information and all related tasks with status. The “move to history” function will move the database entry from the “visits” table to the “history visits” table and it will move the visit tasks from the “tasks” table to the “history tasks” table for the selected visit only.

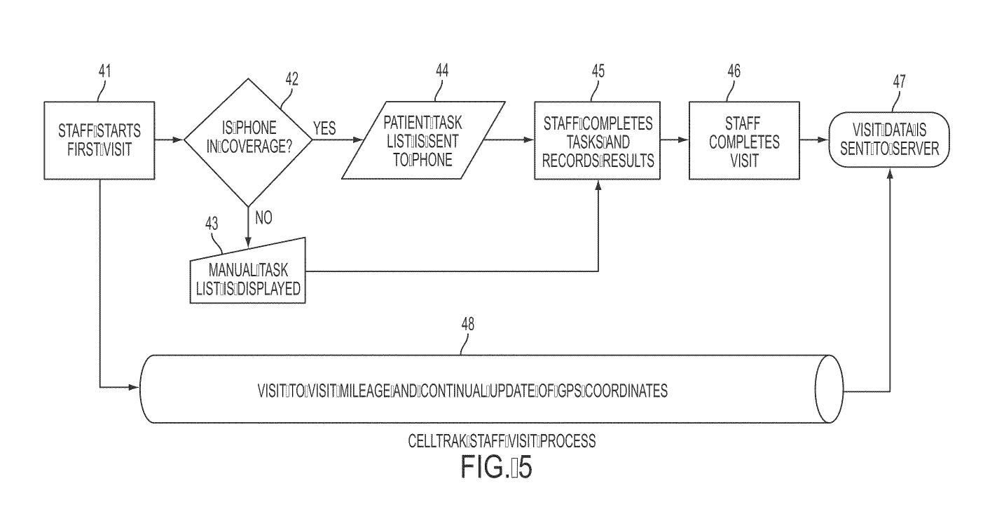

Referring to FIG. 5, the steps related to a field service agent (e.g. a caregiver) using the mobile application device 102 during the process of a field visit, according to one embodiment, are shown. Note that these steps could also be carried out by communication device 101, among other possibilities, without departing from the scope of the claims. In block 41 the field service agent interacts with the mobile application device 102 and initiates a first visit component associated with the software-based client application of the mobile application device 102. In block 42, FIG. 5, it is determined if the mobile application device 102 is in coverage for telephonic and/or data communication. If the mobile application device 102 is not in coverage, then in block 43, a manual task list is displayed listing the tasks to be accomplished by the field agent using the mobile application device 102. Processing then proceeds to block 45, in which the field service agent completes tasks and records results.

If the mobile application device 102 is in coverage, then in block 44, FIG. 5, a patient task list is transmitted from the server system 104 to the mobile application device 102 operated by the agent in the field. In block 45, the field service agent completes tasks and records results. In block 46, the field service agent completes the visit and in block 47 the visit data gathered and obtained is transmitted by mobile application device 102 for receipt by the server computer 114 of the server system 104. Throughout this process, in block 48, the GPS application records visit-to-visit mileage and continues to provide updates of the GPS coordinates of the location of the mobile application device 102 to the server system 104.

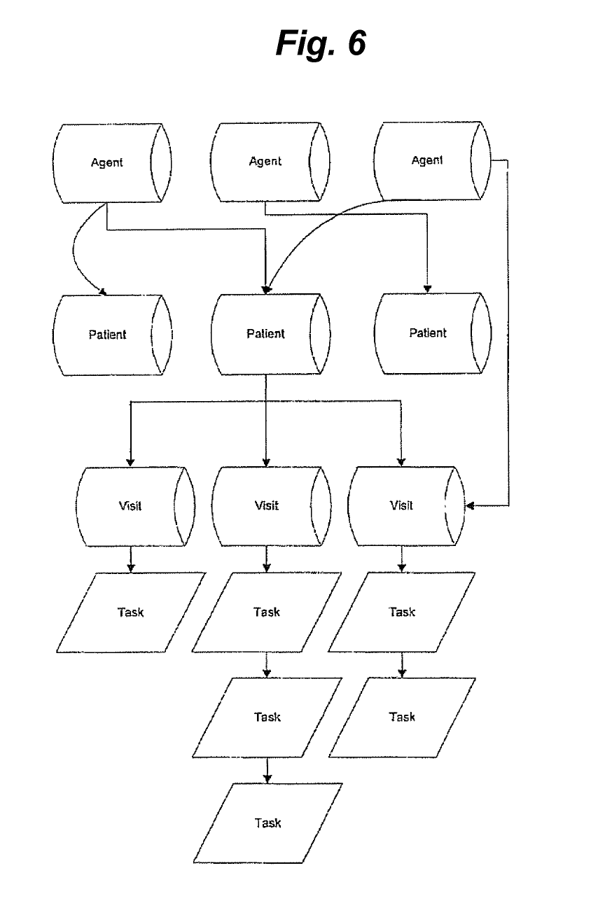

As seen in FIG. 6, a representation model illustrating an example of relationships between the agents using communication devices 101, the patients, and the visits and tasks performed is shown. An “agent” refers to a user. For the purposes herein, this user may be the field personnel staff member (e.g. caregiver) that goes to a particular patient to perform tasks. A “patient” may refer to an individual that the agent will service.

A “task” is a duty that is to be performed on a patient. Examples of tasks could be, but are not limited to: taking a patient's temperature, recording the date of the patient's last bowel movement, washing the patient's hair, etc. There is, therefore, a one-to-many relationship between patients and tasks. Each patient might have several, if not dozens of tasks that can be assigned to them. A “visit” may refer to a particular instance of an agent performing a set of tasks. A visit preferably has a one-to-one relationship with a patient. A visit may selectively only correspond to one patient. Note, however, that one patient might have several visits associated with them (i.e. the relationship between patients and visits is one-to-many) as seen in FIG. 6.

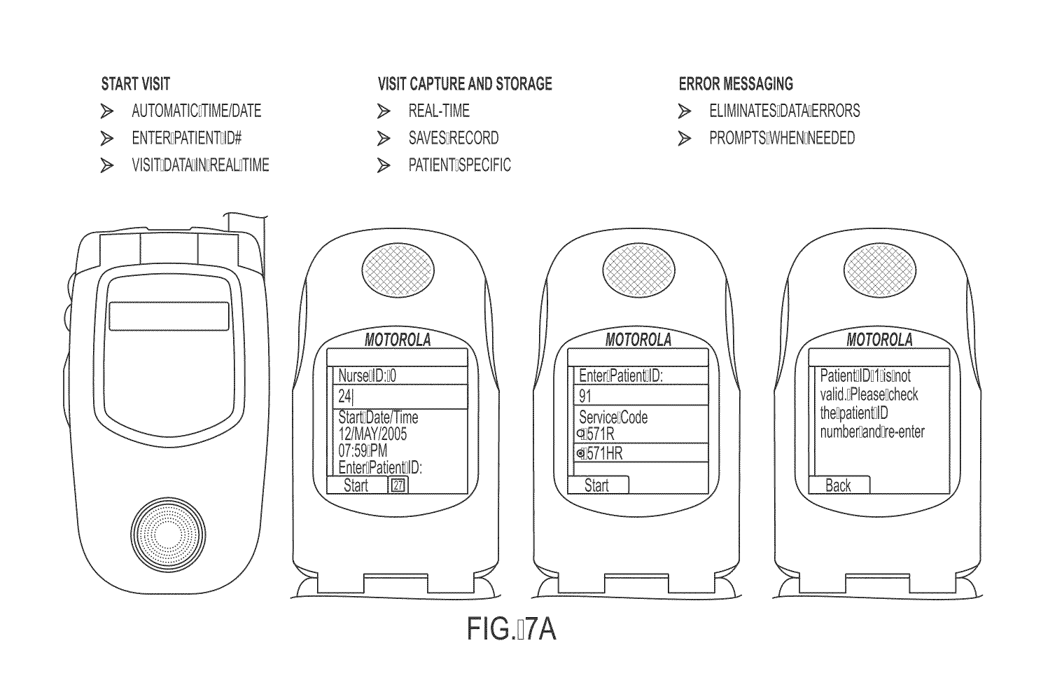

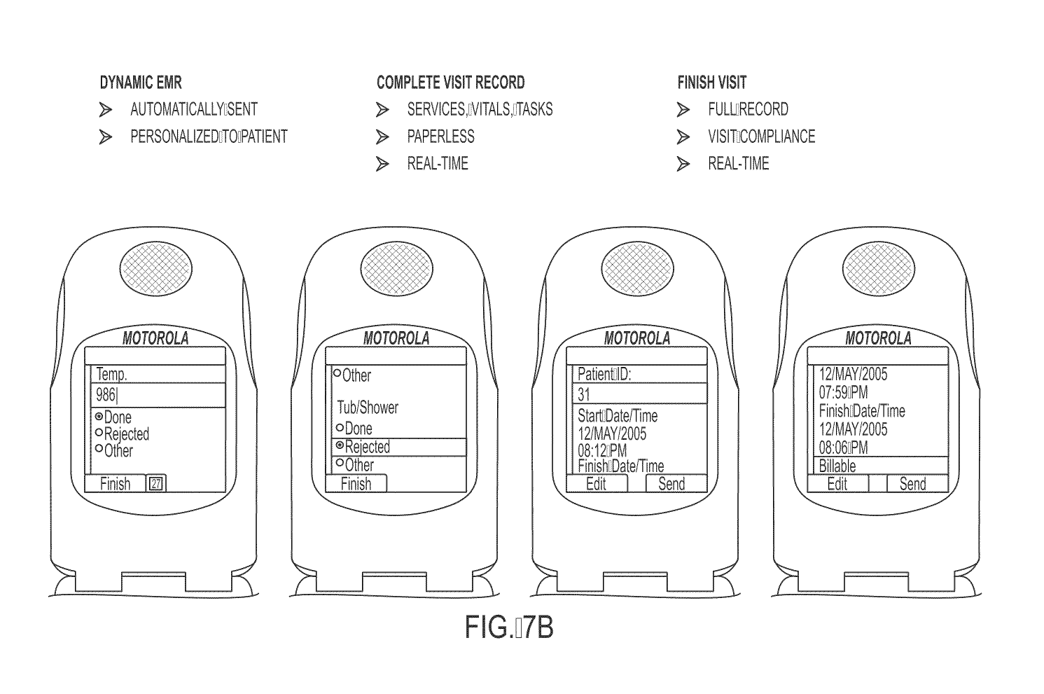

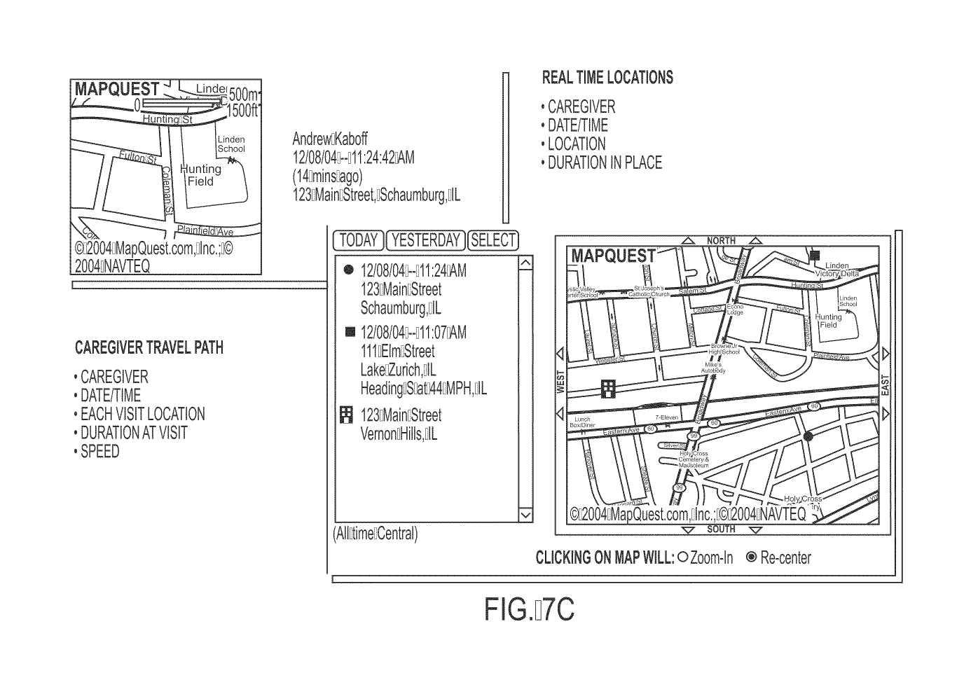

FIGS. 7A through 36 illustrate representative screen shots for the applications and modules described above. These screen shots are merely examples, and other alternative implementations are also intended to be included within the scope of various embodiments of the invention.

FIG. 7A shows pictorial representations of a display screen for communication device 101, showing an initialization procedure, according to one embodiment of the invention.

FIG. 7B shows pictorial representations of a display screen for communication device 101, showing data inputs to complete tasks and a conclusion procedure, according to one embodiment of the invention.

FIG. 7C shows a pictorial representation of a display screen for a web portal server computer 114, showing a map-based tracking application, according to one embodiment of the invention.

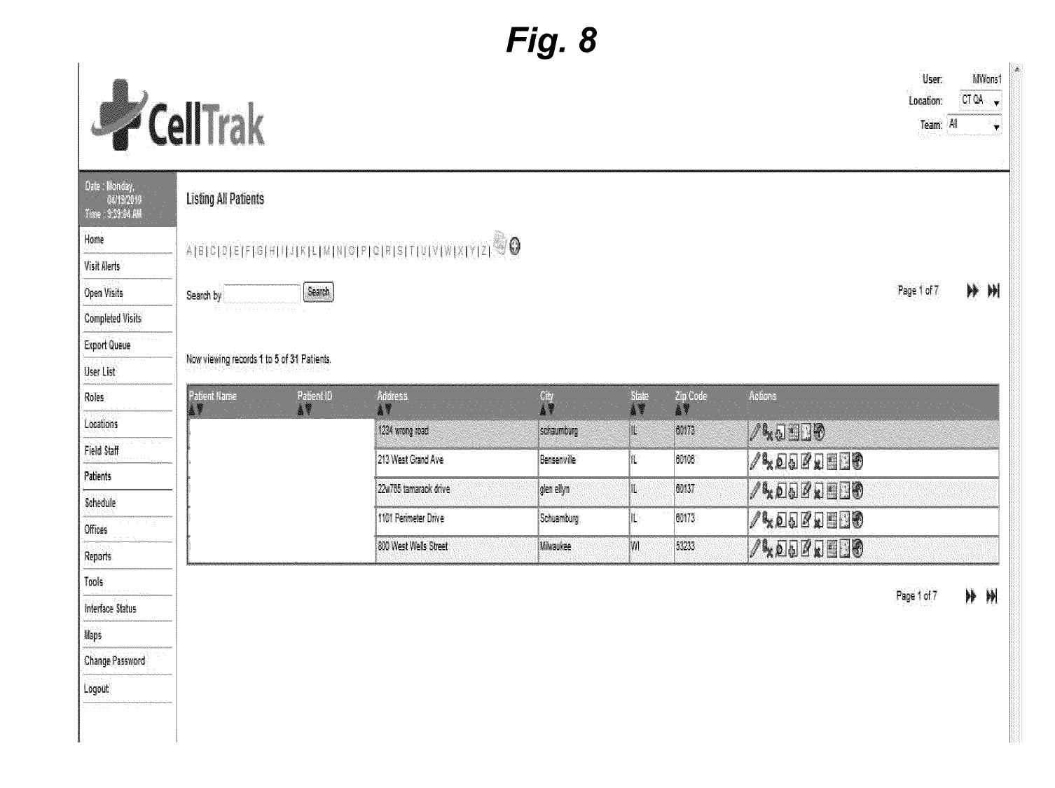

FIG. 8 shows a pictorial representation of a display screen for a web portal server computer 114, showing a patient database, according to one embodiment of the invention.

FIG. 9 shows a pictorial representation of a display screen for a web portal server computer 114, showing a task-list editing application, for designing a patient's care plan, according to one embodiment of the invention.

FIG. 10 shows a pictorial representation of a display screen for a web portal server computer 114, showing a patient record editing interface, according to one embodiment of the invention.

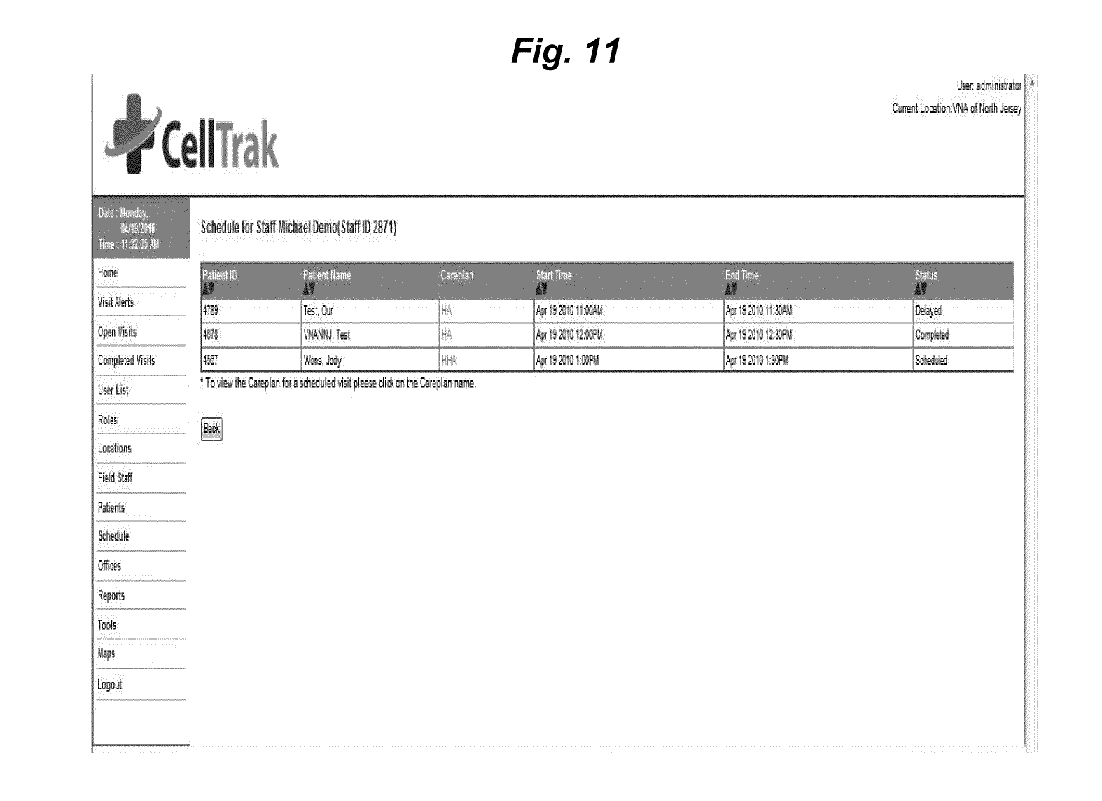

FIG. 11 shows a pictorial representation of a display screen for a web portal server computer 114, showing a staff scheduling application, according to one embodiment of the invention.

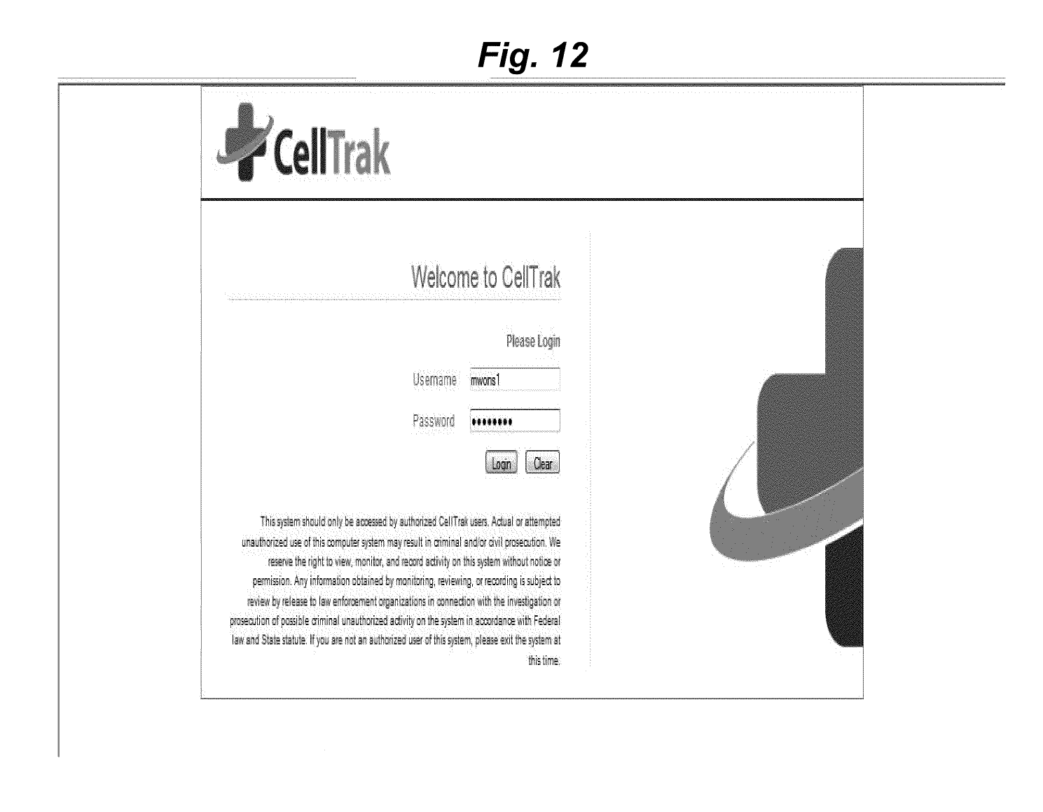

FIG. 12 shows a pictorial representation of a display screen for a web portal server computer 114, showing a login screen according to one embodiment of the invention.

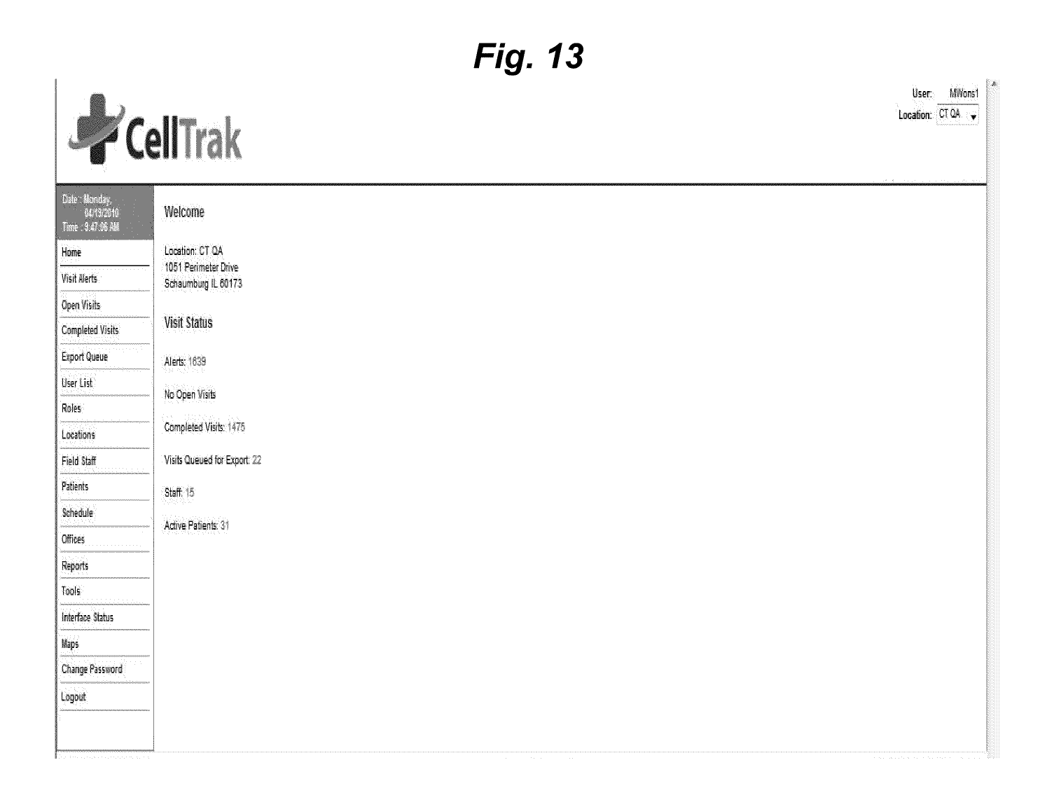

FIG. 13 shows a pictorial representation of a display screen for a web portal server computer 114, showing a visit status summary screen, according to one embodiment of the invention.

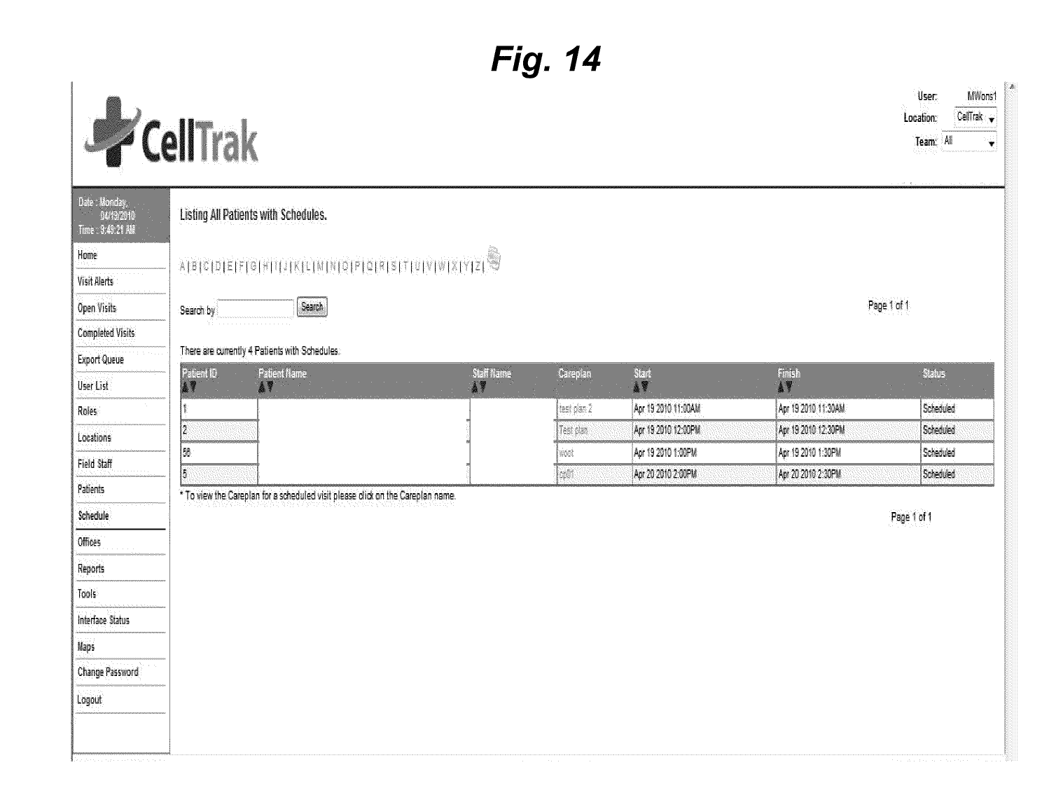

FIG. 14 shows a pictorial representation of a display screen for a web portal server computer 114, showing an “open visits” summary screen, according to one embodiment of the invention.

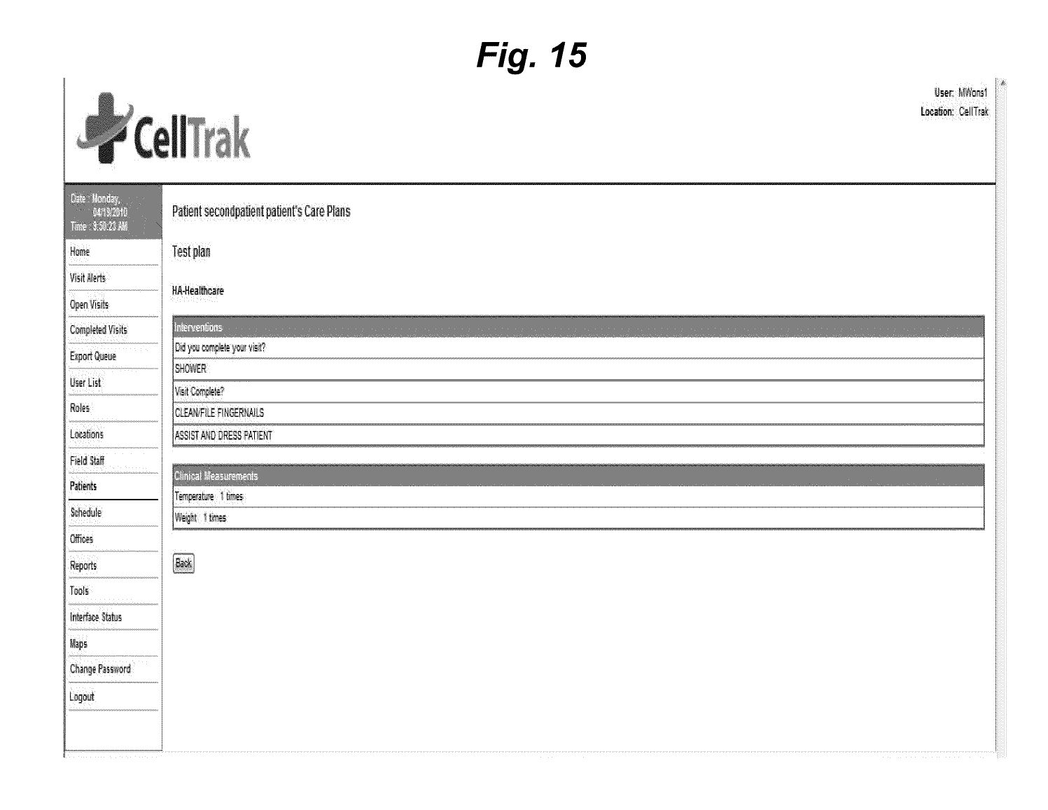

FIG. 15 shows a pictorial representation of a display screen for a web portal server computer 114, showing an “open visit” details screen, according to one embodiment of the invention.

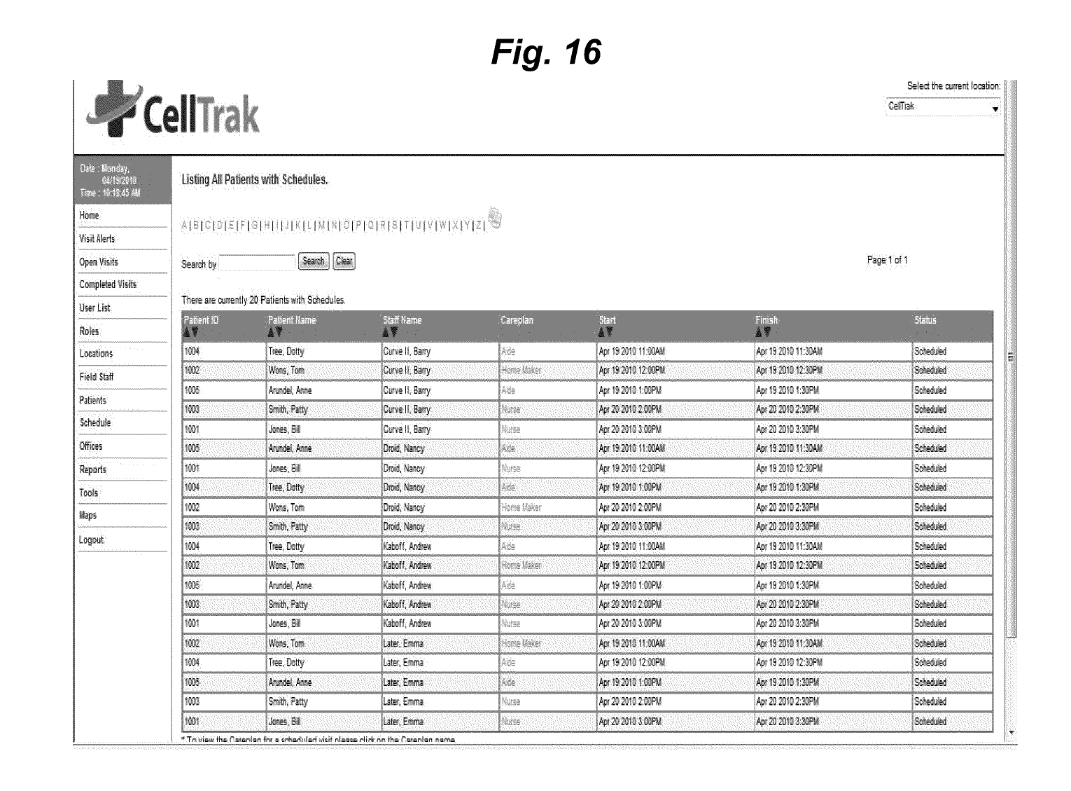

FIG. 16 shows a pictorial representation of a display screen for a web portal server computer 114, showing a “pending visits” summary screen, according to one embodiment of the invention.

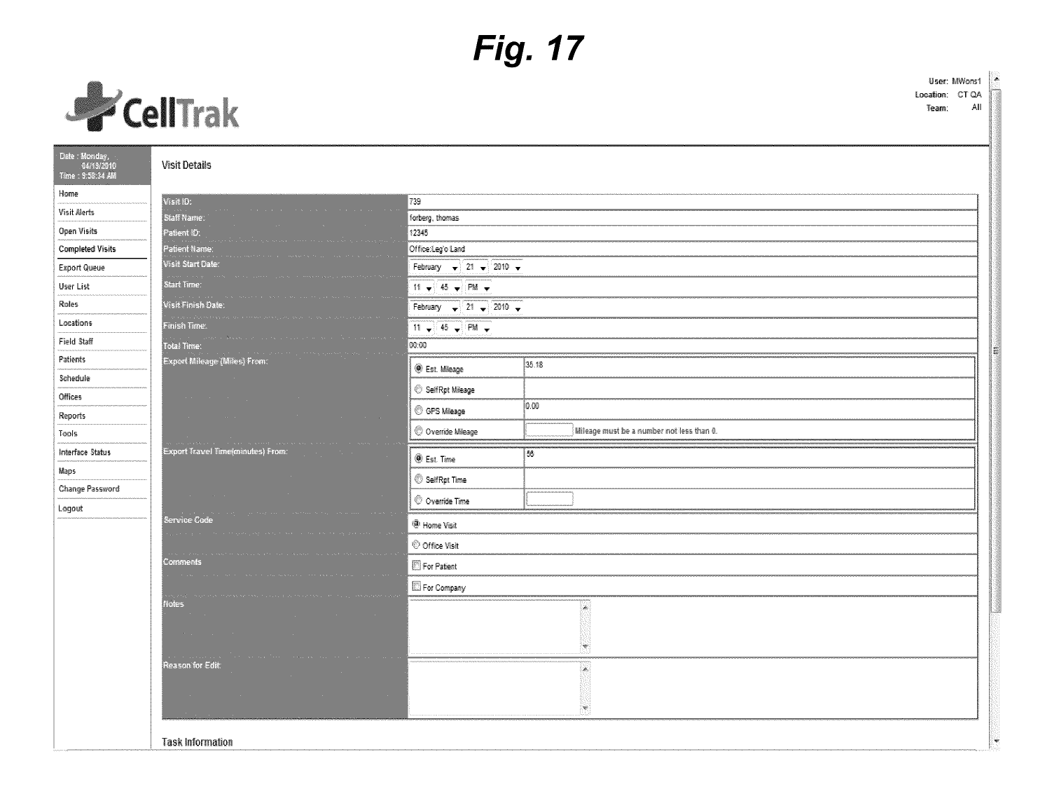

FIG. 17 shows a pictorial representation of a display screen for a web portal server computer 114, showing a “pending visits” details screen, according to one embodiment of the invention.

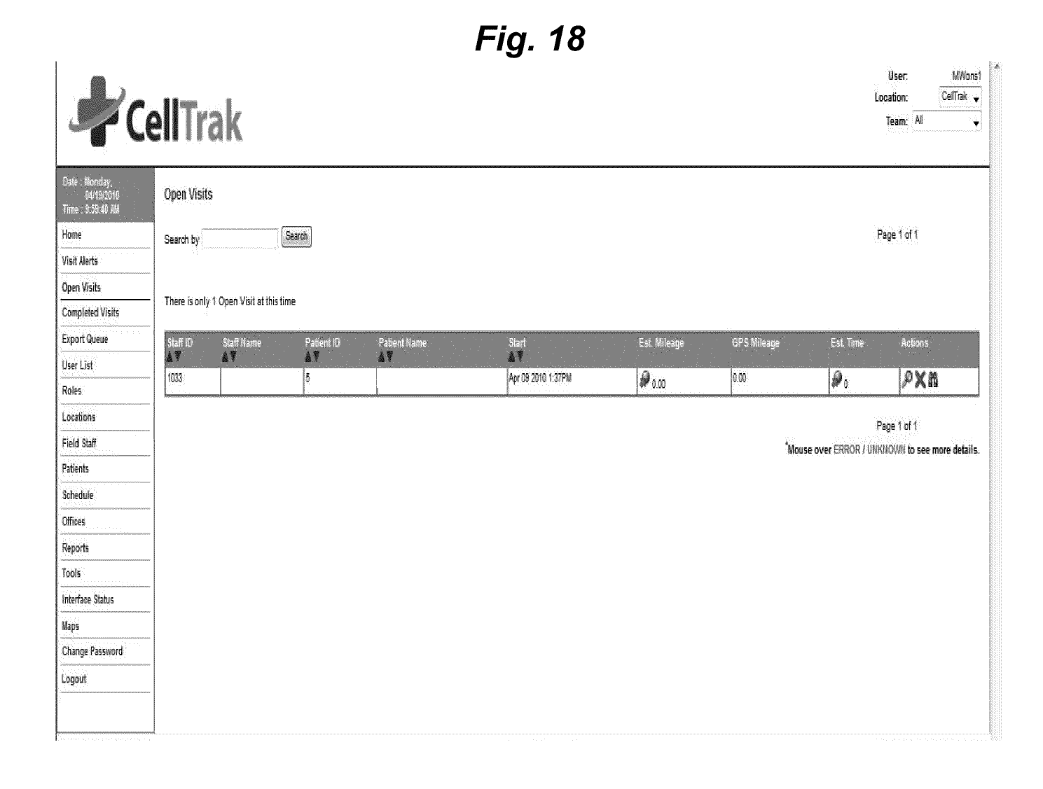

FIG. 18 shows a pictorial representation of a display screen for a web portal server computer 114, showing an “approved visits” screen, according to one embodiment of the invention.

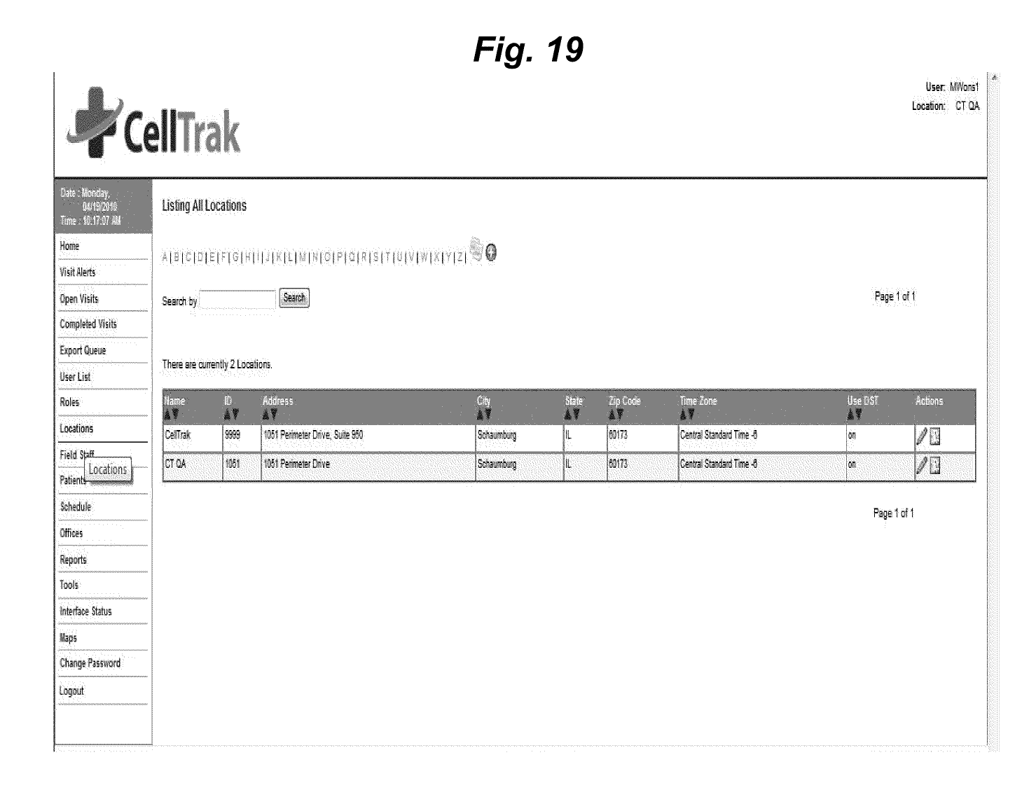

FIG. 19 shows a pictorial representation of a display screen for a web portal server computer 114, showing a “patient reports” summary screen, according to one embodiment of the invention.

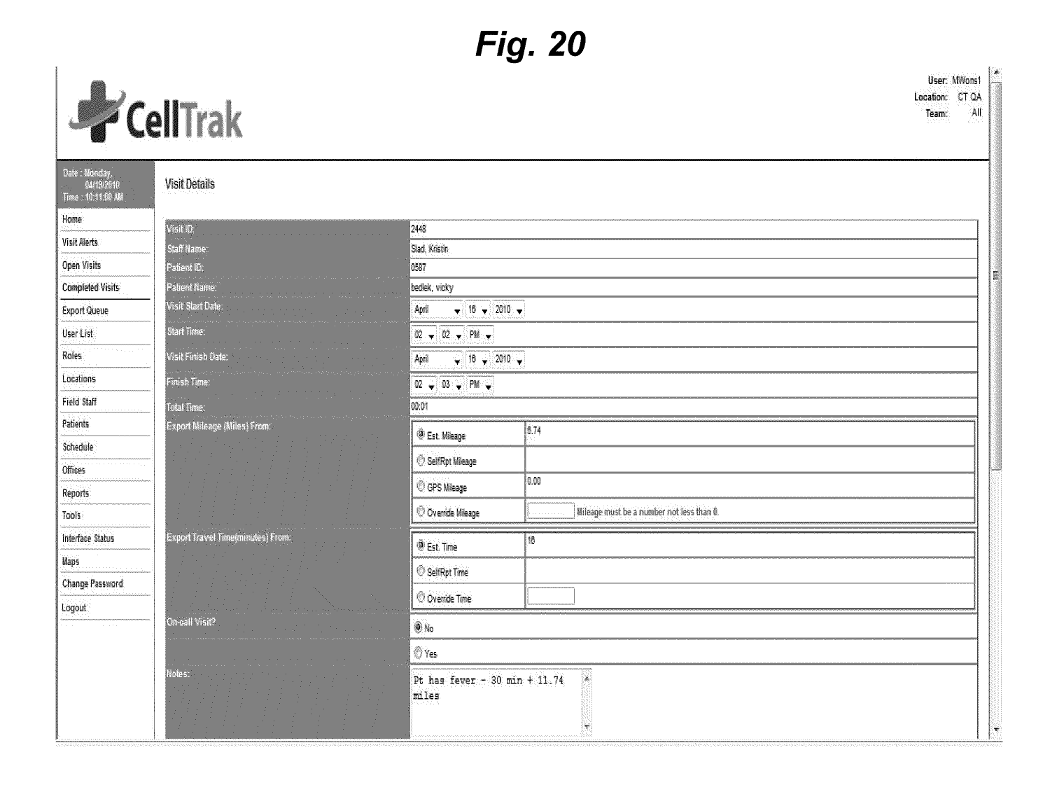

FIG. 20 shows a pictorial representation of a display screen for a web portal server computer 114, showing a sample patient report, according to one embodiment of the invention. As shown in FIG. 20, various attributes (such as start time, finish time, estimated travel distance, and estimated travel time) may be set and displayed for a particular visit.

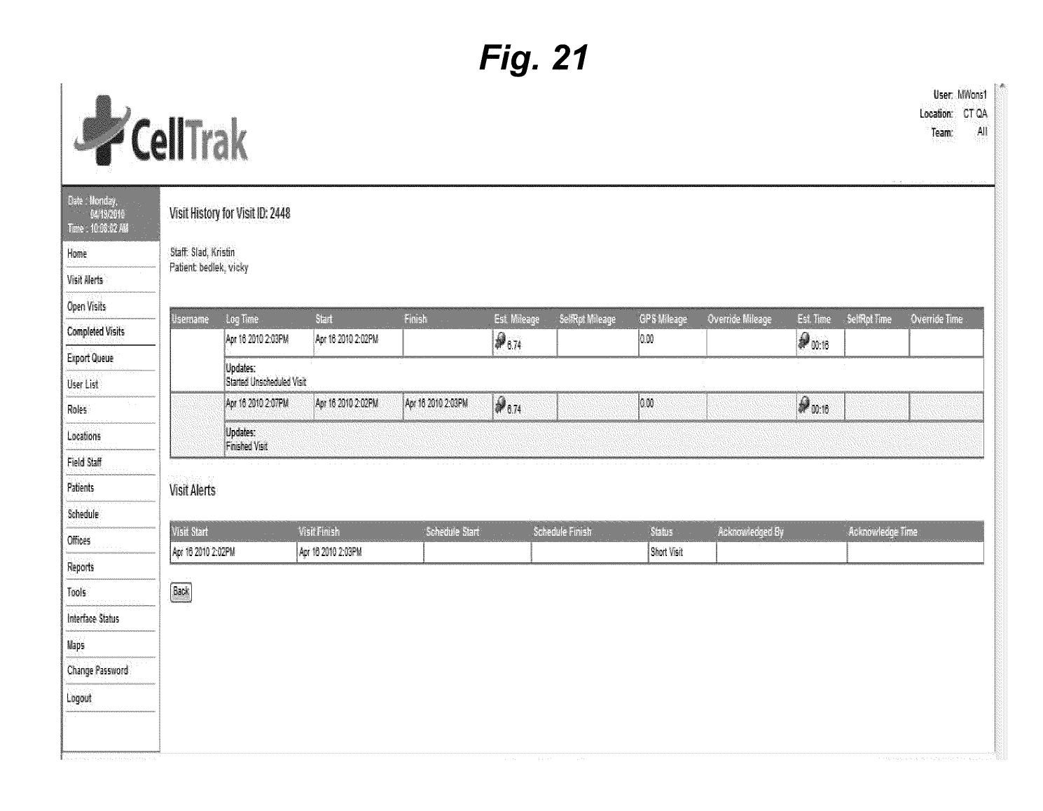

FIG. 21 shows a pictorial representation of a display screen for a web portal server computer, showing a “visit history” screen, according to one embodiment of the invention.

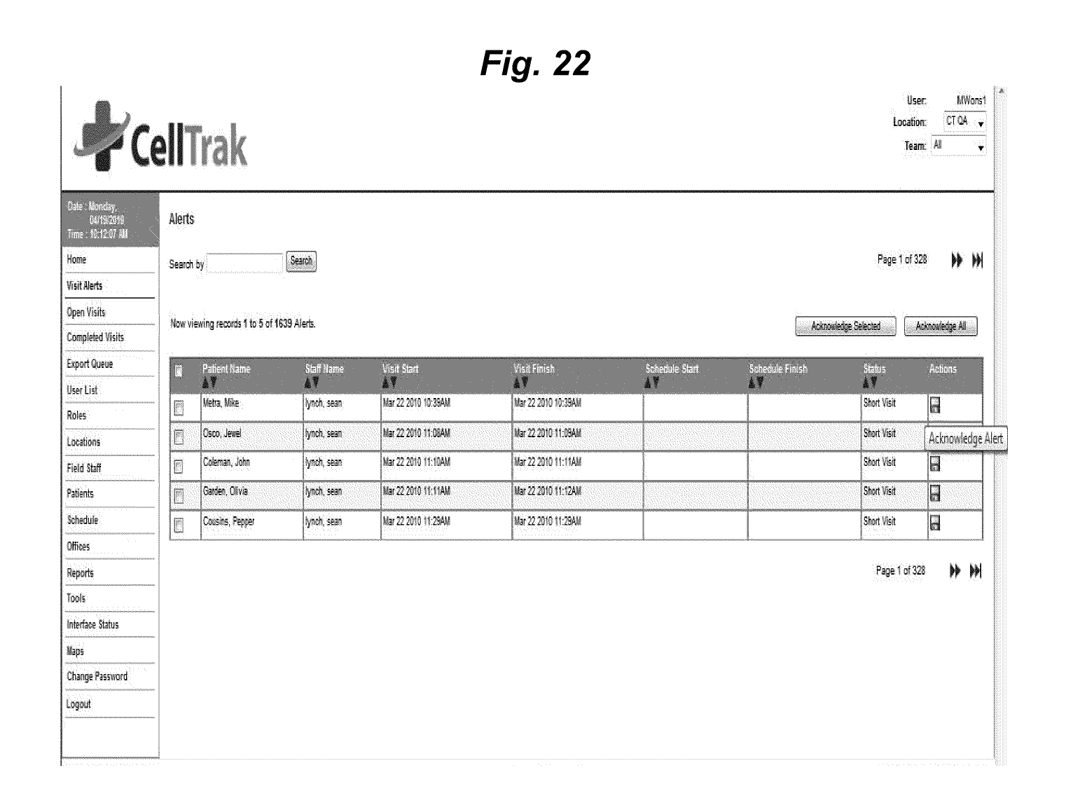

FIG. 22 shows a pictorial representation of a display screen for a web portal server computer, showing a “visit alert” screen, according to one embodiment of the invention. As shown in FIG. 22, an alert may be presented via the visit alert screen to notify office administration of various abnormalities related to a visit. For example, a “short visit” alert may be presented if a caregiver spends a less-than-expected amount of time at a patient's home, perhaps thereby indicating that certain tasks for a visit were skipped (or that the visit was skipped altogether).

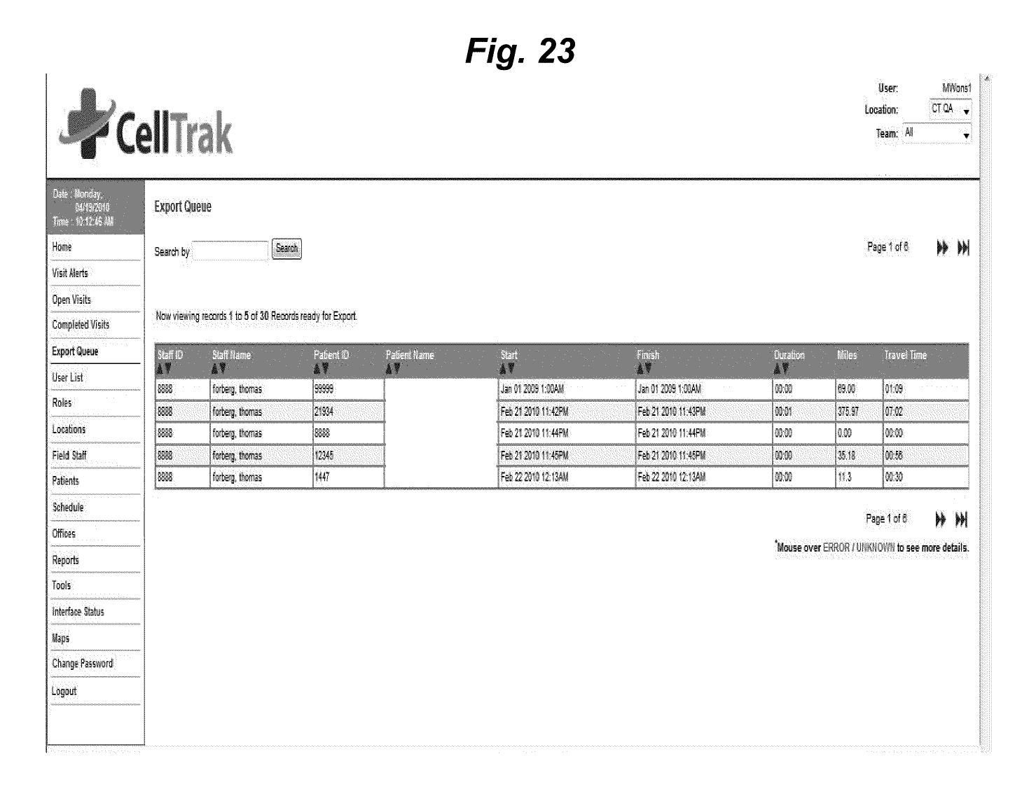

FIG. 23 shows a pictorial representation of a display screen for a web portal server computer, showing an “export queue” screen, according to one embodiment of the invention. The export queue screen may be used to indicate which records are ready for exporting to various other systems or modules present in the home care administration system.

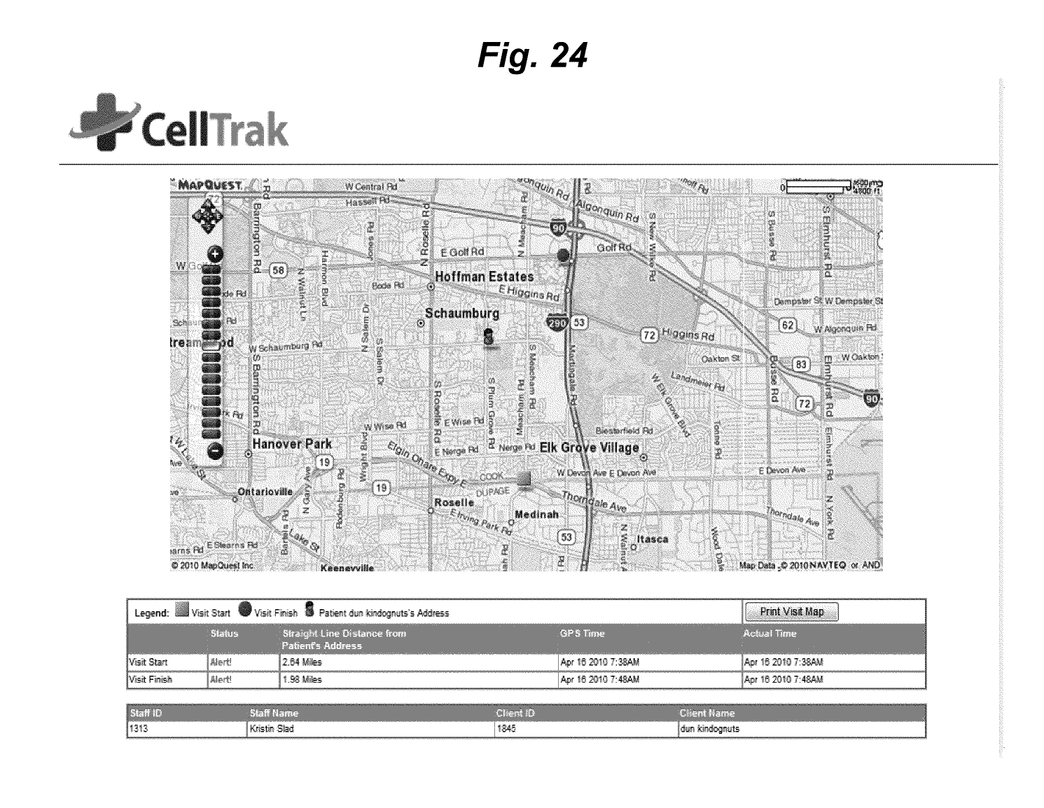

FIG. 24 shows a pictorial representation of a display screen for a web portal server computer, showing a “visit map” screen, according to one embodiment of the invention. As shown, real-time location information for one or more caregivers may be presented on a map. Additionally, an alert may be displayed if a caregiver is not traveling a determined path to the patient's home (perhaps thereby indicating that the caregiver is making non-work-related stops).

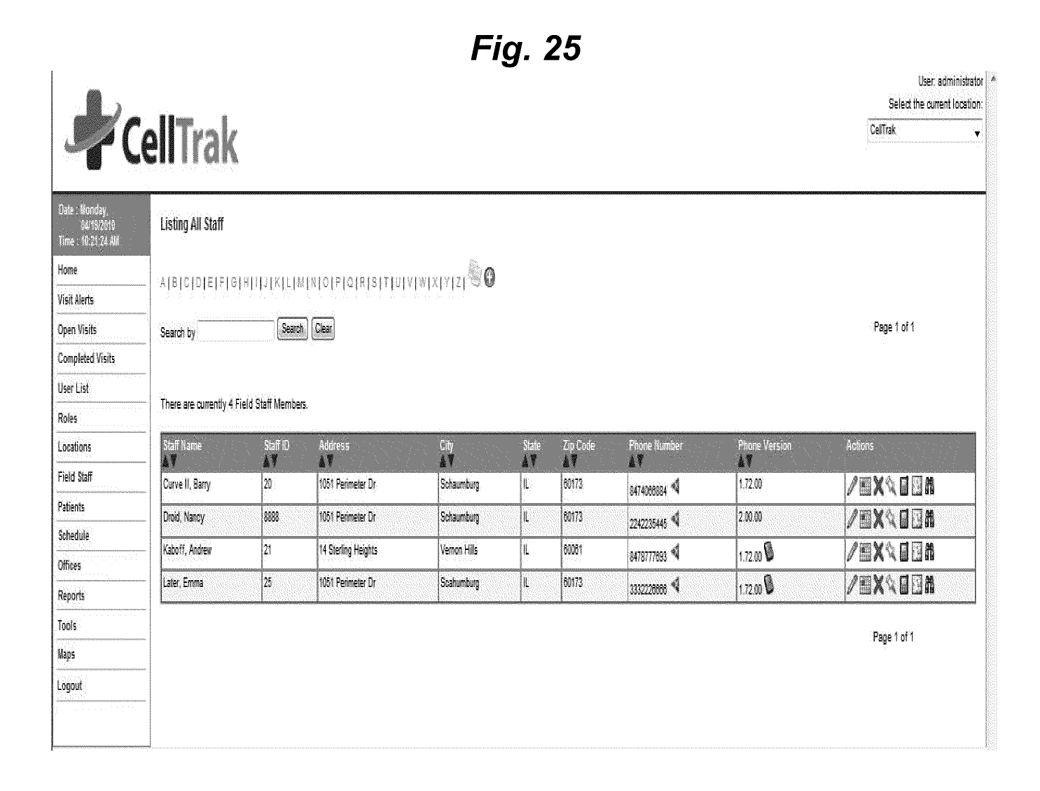

FIG. 25 shows a pictorial representation of a display screen for a web portal server computer, showing a staff listing screen, according to one embodiment of the invention.

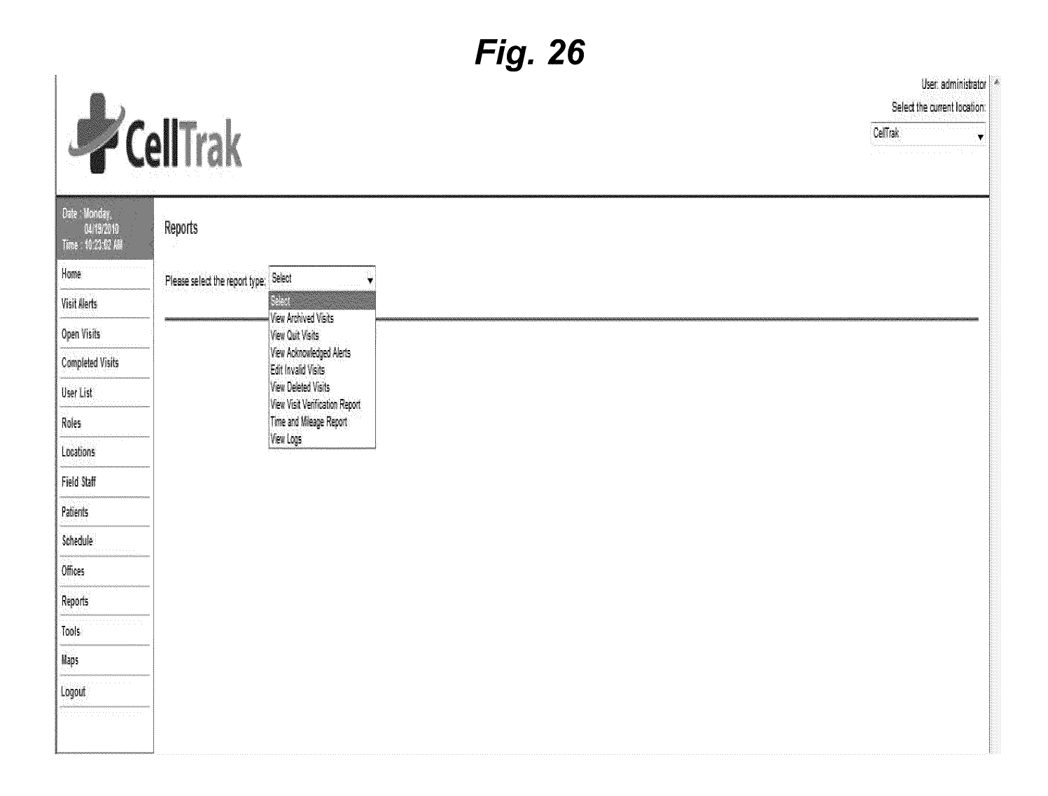

FIG. 26 shows a pictorial representation of a display screen for a web portal server computer, showing a report selection screen, according to one embodiment of the invention.

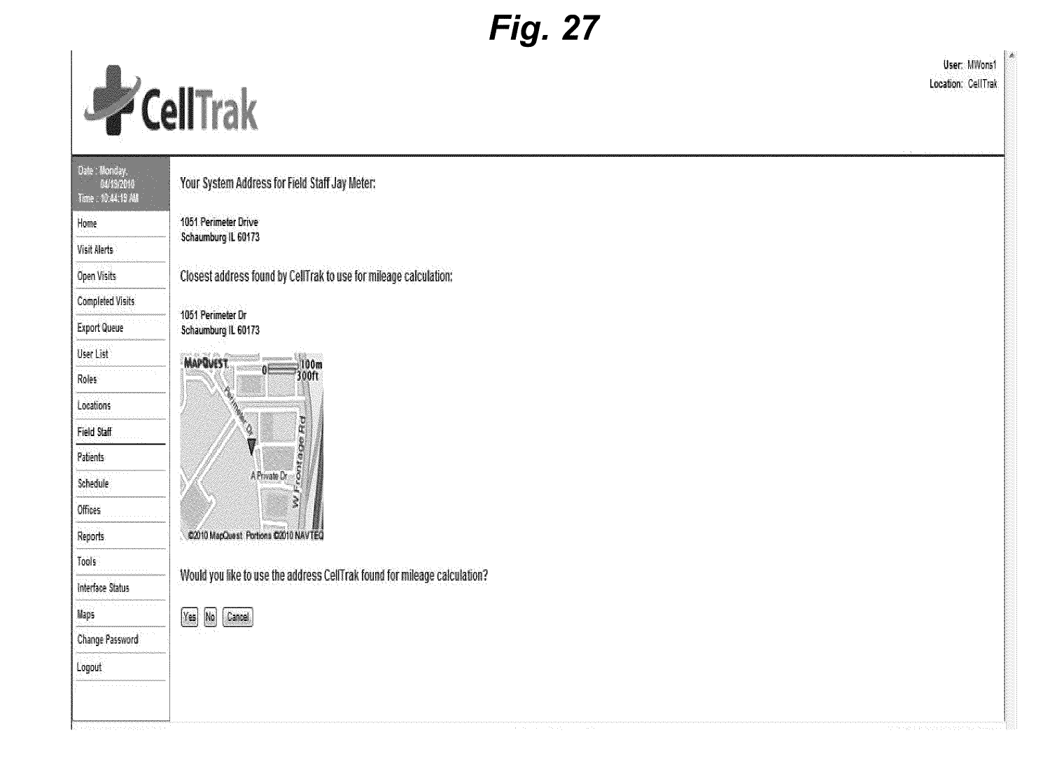

FIG. 27 shows a pictorial representation of a display screen for a web portal server computer, showing an address validation screen, according to one embodiment of the invention.

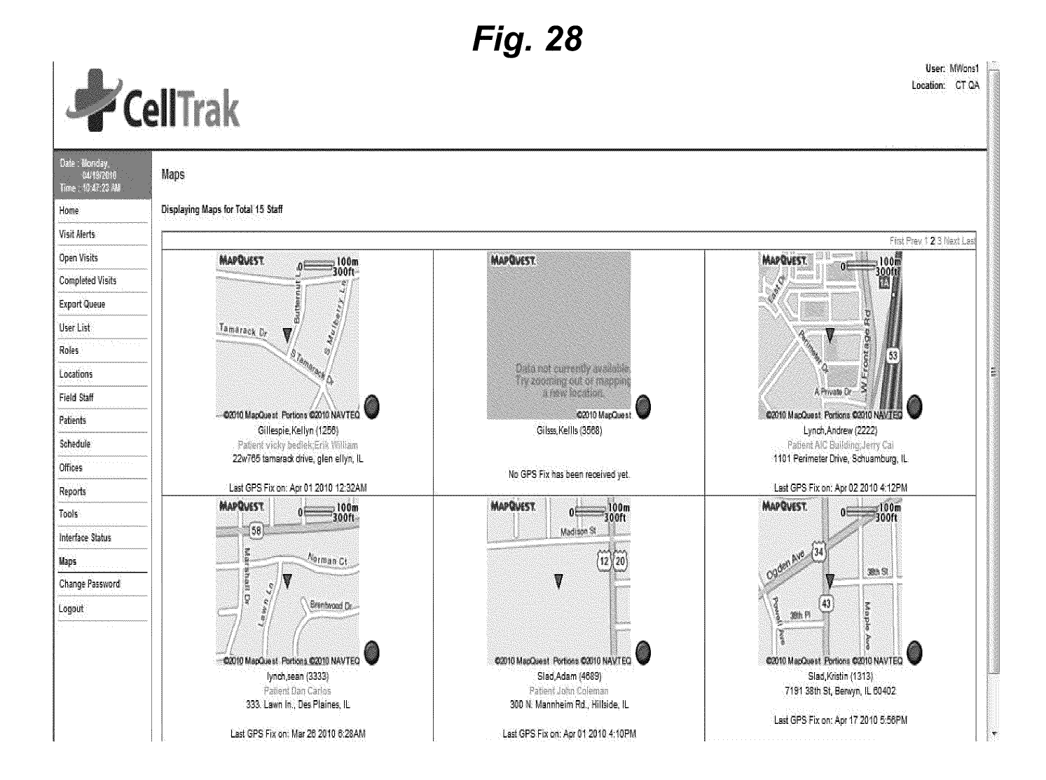

FIG. 28 shows a pictorial representation of a display screen for a web portal server computer, showing a staff location screen, according to one embodiment of the invention. As shown, the staff location screen could display, on a map, the present location of one or more caregivers. An indicator next to the map could indicate whether the location of the caregiver is being tracked in real-time using GPS; a green indicator may signify that the location is being tracked in real-time, while a red indicator may signify that location information for the caregiver is not presently available.

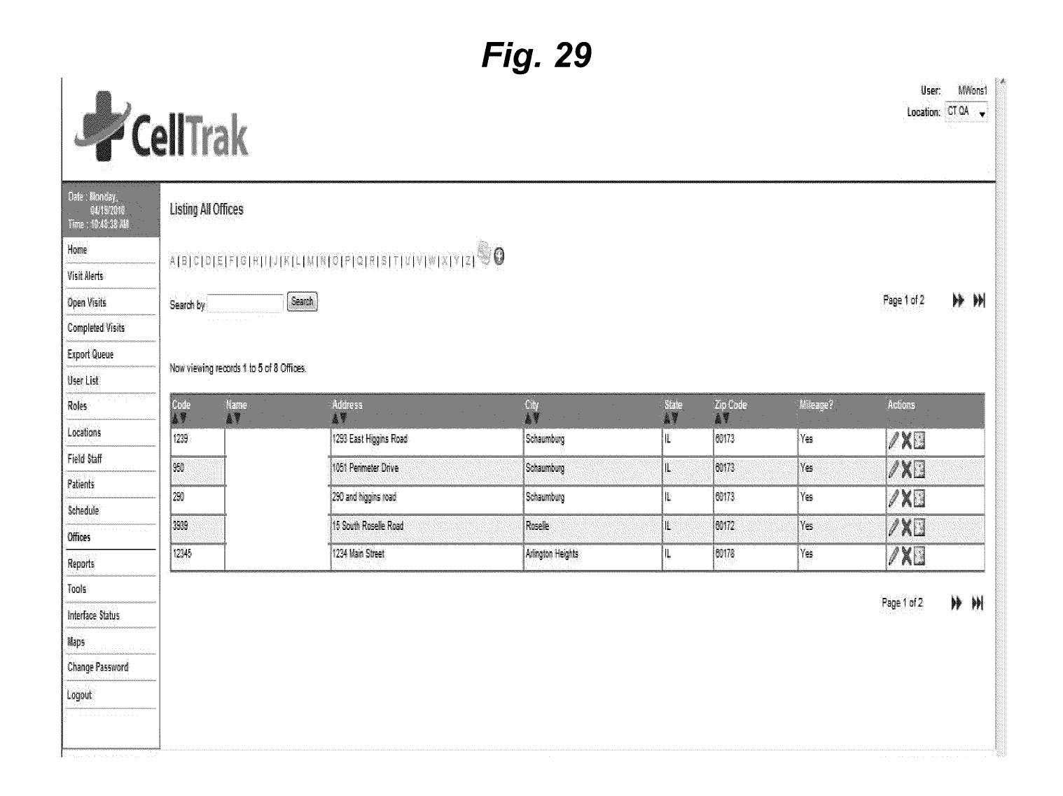

FIG. 29 shows a pictorial representation of a display screen for a web portal server computer, showing an office location screen, according to one embodiment of the invention.

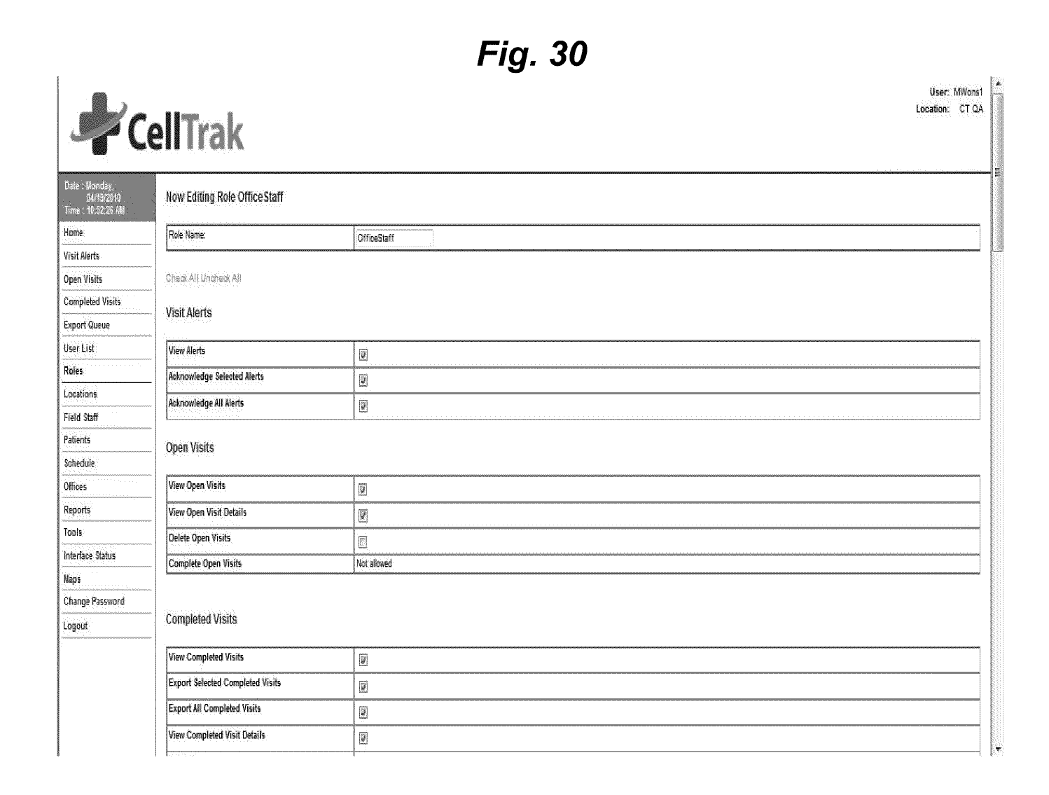

FIG. 30 shows a pictorial representation of a display screen for a web portal server computer, showing a staff roles and responsibilities edit screen, according to one embodiment of the invention. As shown, various permissions may be set for a particular office administrator or caregiver.

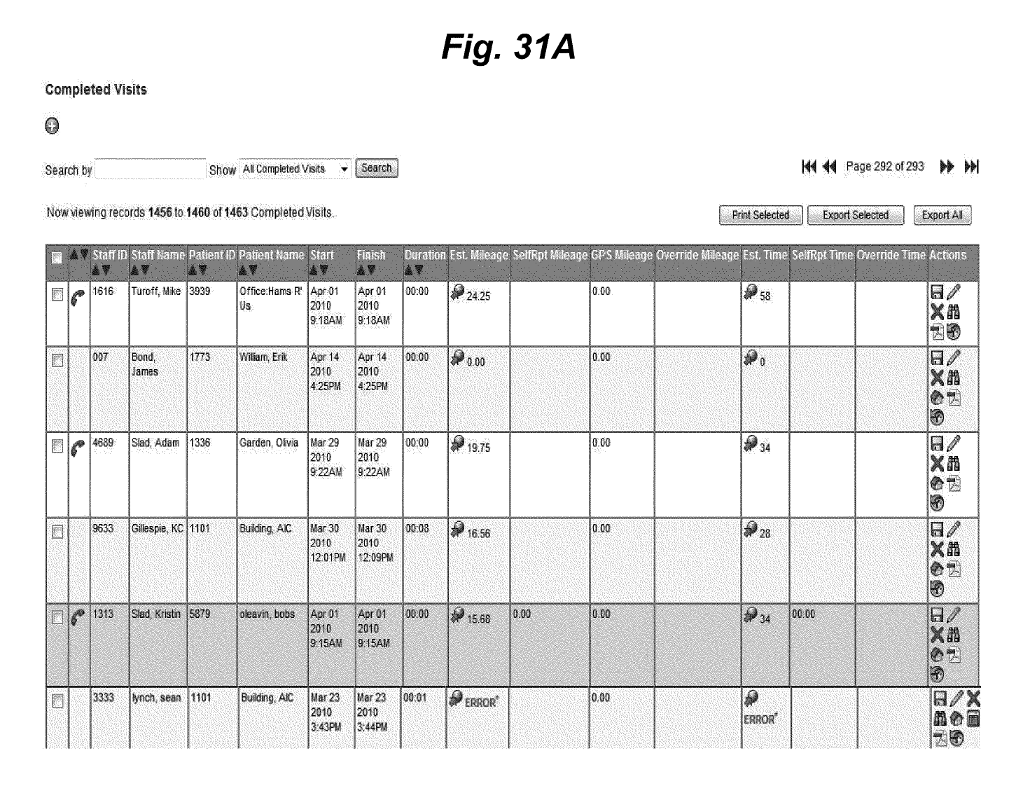

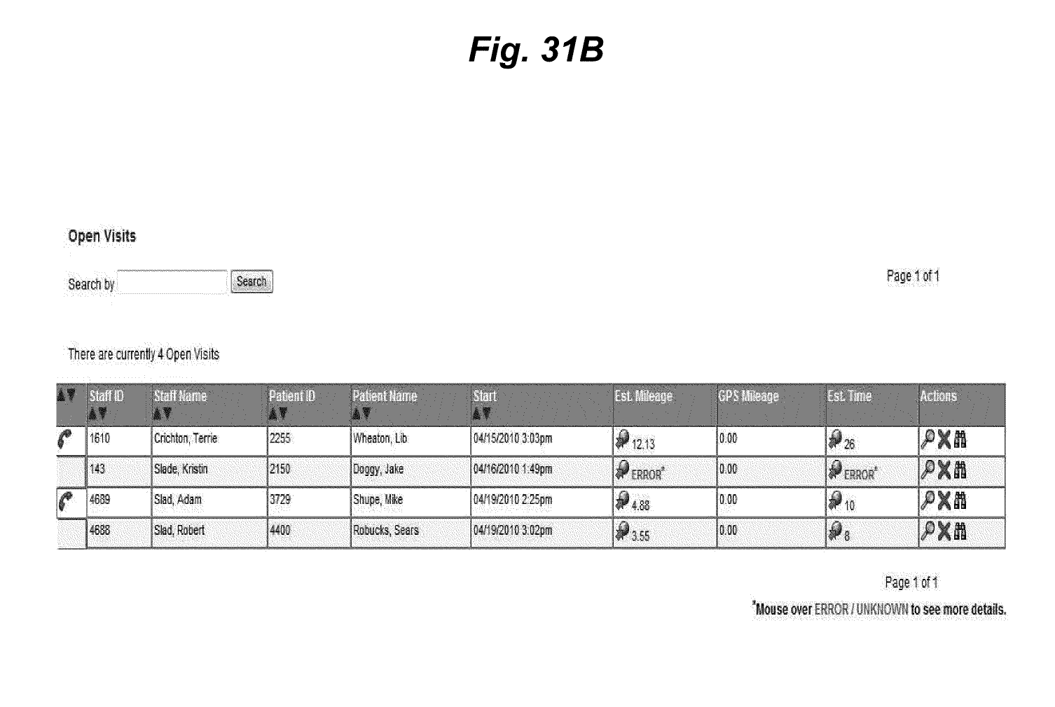

FIGS. 31A and 31B show a pictorial representation of a display screen for a web portal server computer, showing a list of visits conducted using IVR or using an application device. As shown, a telephone icon in the second column for a particular row indicates that the visit is being performed (or has been performed) using IVR, while the absence of a telephone icon indicates that the visit is being performed using an application device.

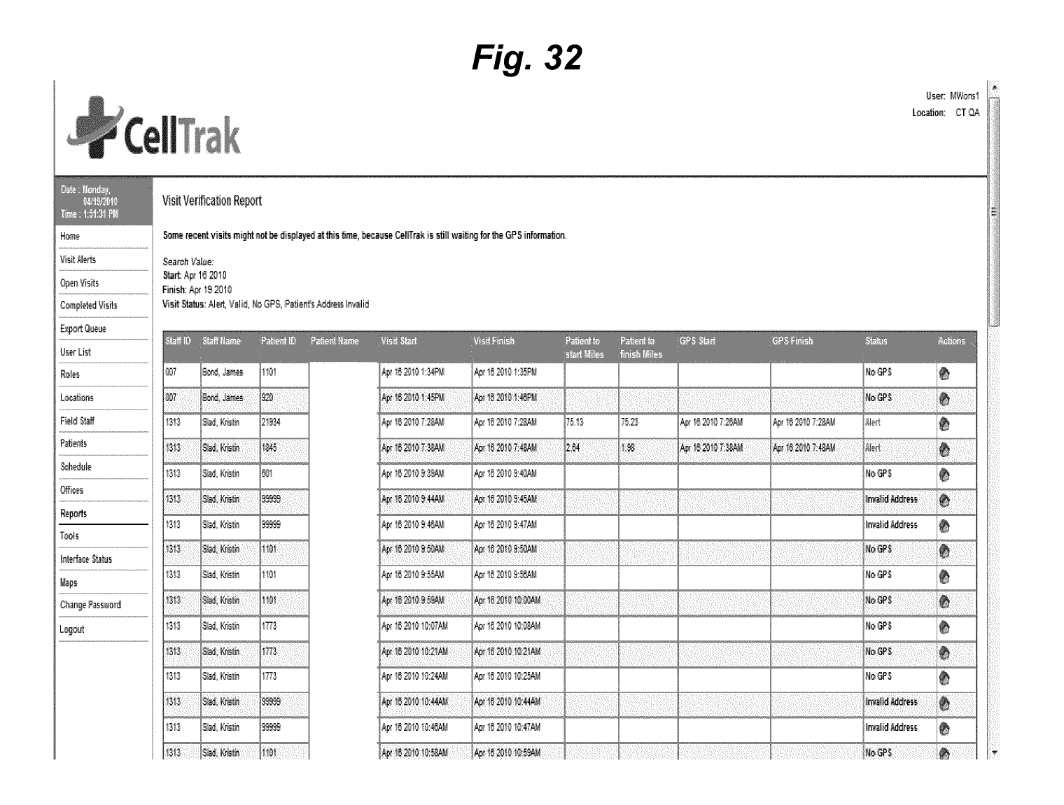

FIG. 32 shows a pictorial representation of a display screen for a web portal server computer, showing a “visit verification report” screen, according to one embodiment of the invention.

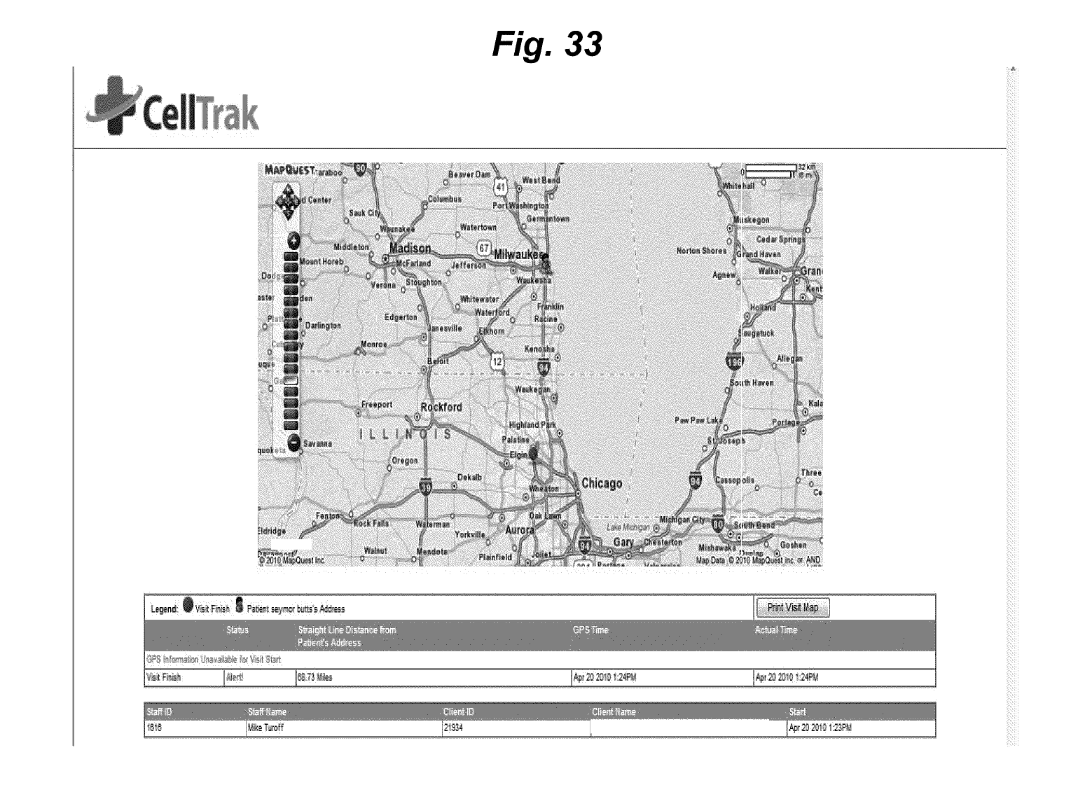

FIG. 33 shows a pictorial representation of a display screen for a web portal server computer, showing a mapping verification screen, according to one embodiment of the invention.

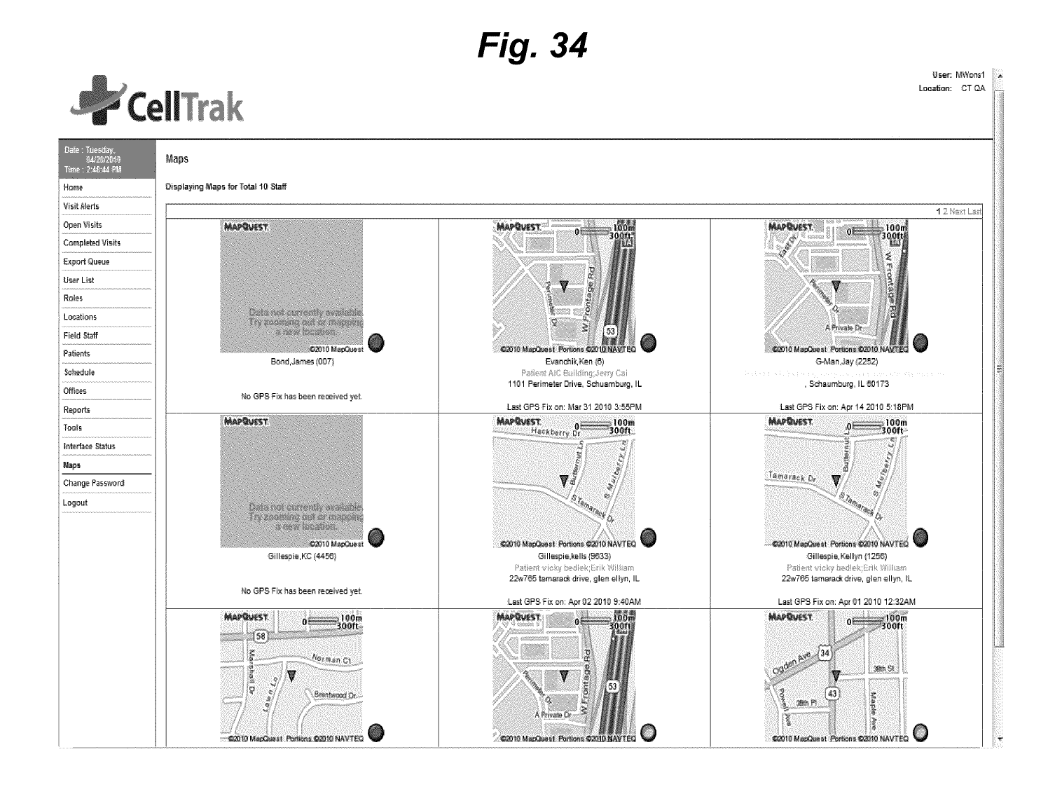

FIG. 34 shows a pictorial representation of a display screen for a web portal server computer, showing a second staff location screen, according to one embodiment of the invention.

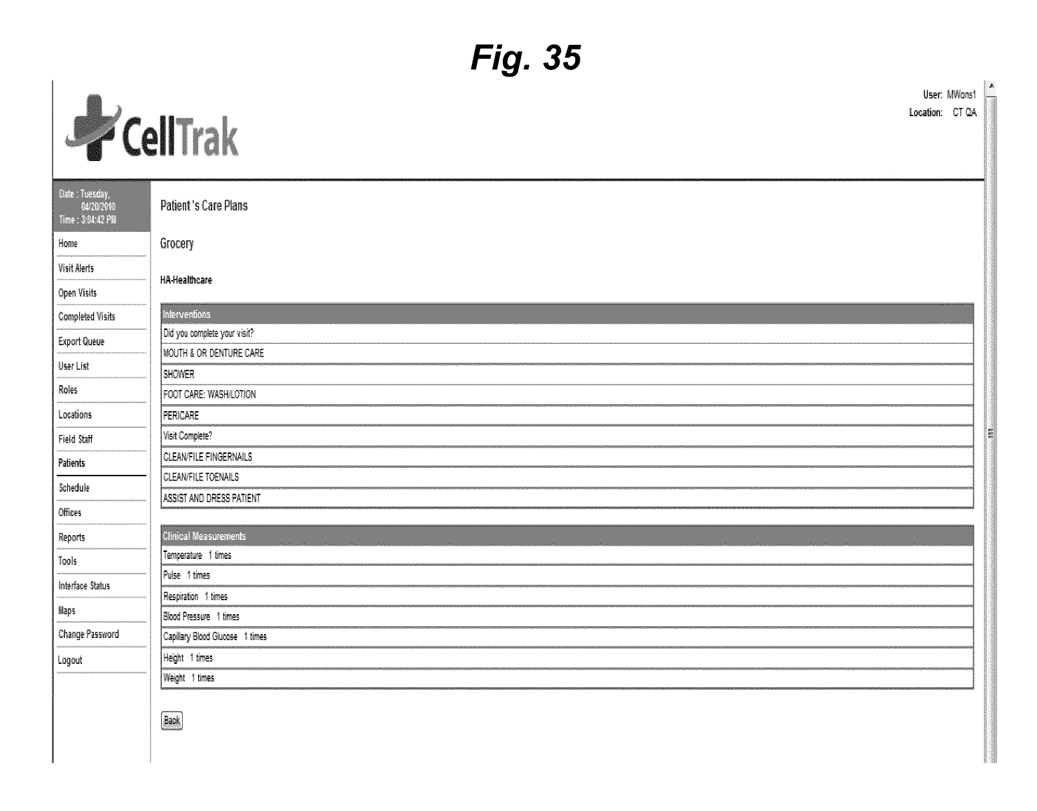

FIG. 35 shows a pictorial representation of a display screen for a web portal server computer, showing a “patient care plan” screen, according to one embodiment of the invention.

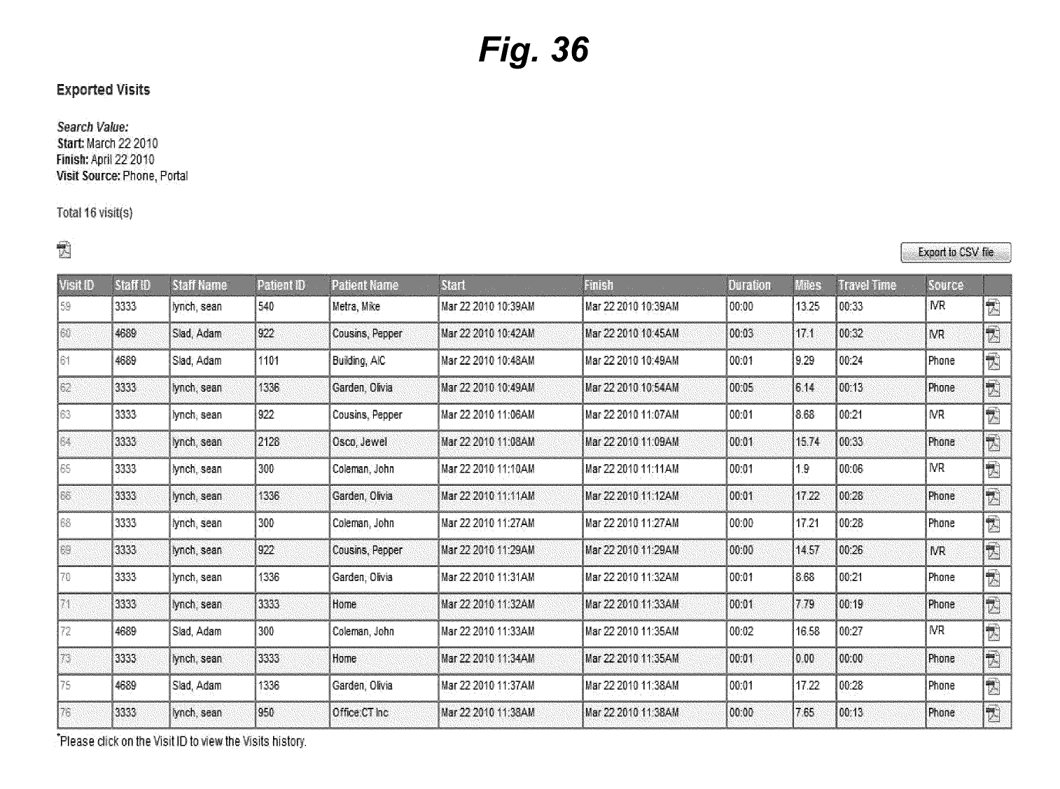

FIG. 36 shows a pictorial representation of a display screen for a web portal server computer, showing an “exported visits” screen, according to one embodiment of the invention.

### 11. Interactive Voice Response (IVR) and Telephony Module

While several of the examples and embodiments have been described with reference to a communication device (e.g., an application device such as a mobile phone or smartphone) that executes program instructions (e.g., a client-side application) for communication with server system 104, communication device 101 may interact with server system 104 even if the communication device does not contain program instructions for the purpose of communicating with server system 104. Rather (or additionally), some or all functions that have been described as being executed by communication device 101 could be performed by server system 104.

For example, traditional landline telephones (such as POTS device 103) generally do not contain a processor and data storage for executing client-side applications, nor do those devices typically include a display. Accordingly, server system 104 may need to perform some or all functions for the communication device, and may need to provide an interface for communication device 101 that does not require the use of client-side applications.

Interactive voice response (IVR) and telephony module 322 allows for server system 104 to provide an interface to communication device 101 that does not require a client-side application on the communication device. Rather, IVR/telephony module 322 may include the ability to receive inputs using traditional telephone keypad inputs (perhaps using dual-tone multi-frequency (DTMF) signaling or pulse dialing), and/or to receive voice input such as voice annotations (and perhaps to convert those voice inputs/annotations to text using speech recognition software). Further, IVR/telephony module 322 may include the ability to convert text forms and associated data into audio representations (perhaps using text-to-speech software), and/or to present pre-recorded audio prompts. Note that while the IVR/telephony features are described herein as part of IVR/telephony module 322, note that some or all of these features could be incorporated into framework 302, and/or any other module that requires such functionality.

IVR/telephony module 322 could present one or prompts and require the caregiver to enter a key press (or voice indication) once a desired prompt has been presented. Additionally or alternatively, IVR/telephony module 322 could present the prompts with associated numbers or names, and allow the caregiver to indicate the desired menu item using a key press or spoken indication of the number/name. Other possibilities for indicating a desired menu item are possible as well without departing from the scope of the claims.

In an embodiment, IVR/telephone module 322 receives from communication device 101 information regarding an identification of the caregiver upon establishing a call with server system 104. In this embodiment, upon arriving at a patient's home, the caregiver may dial a phone number associated with server system 104. The phone number could be, for example, a toll-free number, such that phone-usage charges are not directly billed to the patient or caregiver.

Once a call is established with server system 104, the caregiver may enter a user identification and/or passcode. For example, upon dialing a toll-free number, IVR/telephony module 322 may prompt the caregiver to enter a user identification (perhaps followed by the # sign). Upon the caregiver entering the required identification (IVR/telephony module 322), the IVR/telephony module may then prompt the caregiver for a passcode (again perhaps followed by the # sign). Upon the caregiver entering the required identification (and IVR/telephony module 322 receiving the identification), the IVR/telephony module may then provide one or more prompts corresponding to a main menu.

In another embodiment, IVR/telephone module 322 receives from communication device 101 information regarding the start and/or end of a visit. In this embodiment, upon dialing the toll-free number (and perhaps sending the required identification information to IVR/telephony module 322), the caregiver may use communication device 101 to indicate the start or end of a visit. For example, IVR/telephony module 322 may present a menu item corresponding to an arrival of the caregiver for a visit (perhaps the first menu option presented by IVR/telephony module 322). The module may further present a menu item corresponding to completion/departure of the visit (perhaps corresponding to a second menu option).

IVR/telephony module 322 may record the present time (and date) as the arrival and/or departure time. As another possibility, the caregiver could be prompted to enter an arrival/departure time and date. IVR/telephony module 322 could also record the present time and date as the arrival/departure time by default, but allow the caregiver to change the arrival/departure time/date if necessary. As still another possibility, the caregiver could change the arrival and/or departure time/date in a subsequent call.

IVR/telephony module may require the caregiver to provide a reason for changing the arrival/departure time from the present time. Such reasons could include that the patient's phone was in use, that the patient's phone was not in service, that the patient required immediate care, that the caregiver and/or patient had a transportation issue and/or a personal issue, bad/inclement weather, a delay in a previous visit, work related delays, and/or “other”, among many other possibilities.

In an embodiment, IVR/telephony module 322 receives information from communication device 101 regarding the type of visit. Examples of the type of visit include a “regular” visit and a “close” visit, for example, if the patient is not home or if the patient rejected care from the caregiver. The type of prompts presented by IVR/telephony module 322 could vary based on the type of visit selected. For example, if the visit type is a close visit because the patient wasn't home, then IVR/telephony module 322 may not need to present any additional prompts.

IVR/telephony module 322 may require information regarding the particular patient for the visit. IVR/telephony module 322 could obtain this information using, for example, caller ID. The module could then associate the phone number of the calling phone with a database of known patient phone numbers to determine which patient the caregiver is visiting. If the caregiver is not calling from the patient's phone (or for other reasons), IVR/telephony module could require the caregiver to provide a patient identifier (perhaps a number entered into the keypad or a spoken name of the patient).

In an embodiment, IVR/telephony module could require the caregiver to provide information, via communication device 101, regarding tasks performed during the visit. Those tasks may include bathing, grooming, doing laundry, providing meals, housekeeping, and/or transferring or transporting the patient, among other possibilities. IVR/telephony module 322 could prompt the caregiver with each task, and require the caregiver to enter a status for each task. The status could be, for example, that the task was performed, that the patient refused the task, or that the task is not required. IVR/telephony module 322 could provide an audio representation of the task, and could receive a numeric key input or spoken representation regarding the status of the task, for example.

IVR/system module 322 could require task information after each task is performed, and/or after all tasks are performed, among other possibilities. If IVR/telephony module 322 requires this information only at the end of the visit, then the caregiver (or IVR/telephony module 322) could end the call after providing the module with arrival information, and the caregiver could make a subsequent call at the end of the visit.

In an embodiment, IVR/telephony module 322 provides additional instructions regarding tasks to be performed. As an example, if the caregiver indicates to IVR/telephony module 322 that he or she is to begin the task of preparing a meal for the patient, then IVR/telephony module 322 could provide information regarding allergies of the patient, such that certain foods for the patient should be avoided.

IVR/telephony module 322 could allow the caregiver to receive real-time schedule information via communication device 101. For example, after the caregiver has indicated via communication device 101 that a particular visit is finished, then IVR/telephony module 322 could provide the caregiver with audio information regarding a next visit. Additionally or alternatively, IVR/telephony module 322 could allow the caregiver to modify the schedule using communication device 101, perhaps by providing key inputs or voice inputs corresponding to a next-scheduled visit.

The communication device could be configured to send received inputs to server system 104 in real time, and/or server system 104 could be configured to send information to communication device in real time. In this context, real-time communication could mean at substantially the same time. A landline telephone may be configured to transmit a DTMF signal corresponding to a particular key at substantially the same time as that key is pressed; the key press and transmission of the signal may appear to be simultaneous to the caregiver.

Communication device 101 could transmit images or other data to IVR/telephony module 322 (and server system 104) using a modem. For example, if the communication network that communication device 101 is presently using to communicate with server system 104 is incapable of data packet communication (for example, a POTS or PSTN network), then the modem could be used to convert digital information (such as digital information) to analog signals that represent the information, and to send those analog signals to server system 104 over the network.

In one embodiment, IVR/telephony module 322 determines that inputs entered by the caregiver into communication device 101 are of a correct type. If IVR/telephony module 322 determines that the data input is of the correct type, then IVR/telephony module 322 may determine whether the entered data satisfies an application rule. If the entered data input is not of the correct type, then IVR/telephony module 322 may present an error indication via communication device 101. IVR/telephony module 322 may take a predetermined action in response to determining that the entered data does not satisfy the applicable rule. For example, the predetermined action could include presenting a violated rule indication, providing medical information, and/or providing medical advice.

It should be understood that the illustrated embodiments are examples only and should not be taken as limiting the scope of the present invention. The claims should not be read as limited to the described order or elements unless stated to that effect. Therefore, all embodiments that come within the scope and spirit of the following claims and equivalents thereto are claimed as the invention.

We claim:

1. A method comprising:
providing a schedule comprising one or more visits to a communication device;
receiving a visit-start indication from the communication device that one of the one or more visits has started;
providing to the communication device a list of one or more tasks to be performed, wherein the one or more tasks are associated with the one of the one or more visits;
subsequent to receiving the visit-start indication, receiving a visit-end indication from the communication device that the one of the one or more visits has ended.

2. The method of claim 1, further comprising receiving a task-status indication of a status of at least one of the one or more tasks.

3. The method of claim 1, further comprising using a location of the communication device to determine a travel path to a location where the one of the one or more visits is to be performed, and providing the determined travel path to the communication device.

4. The method of claim 1, further comprising tracking a location of the communication device to determine a path traveled to a location where the one of the one or more visits is to be performed.

5. The method of claim 1, further comprising:
storing an actual-visit-start time that the visit-start indication is received;
storing an actual-visit-end time that the visit-end indication is received;
comparing the actual-visit-start time to an estimated-visit-start time that the visit is estimated to start; and
comparing the actual-visit-end time to an estimated-visit-end time that the visit is estimated to end.

6. The method of claim 5, wherein the estimated-visit-start time is determined based upon an estimated travel time from a previous visit.

7. The method of claim 5, wherein the estimated-visit-end time is determined using the list of one or more tasks.

8. The method of claim 1, wherein providing the schedule to the communication device comprises providing a textual representation of the schedule, and wherein providing to the communication device the list of the one or more tasks to be performed comprises providing a textual representation of the list.

9. The method of claim 1, wherein providing the schedule to the communication device comprises providing an audio representation of the schedule, and wherein providing to the communication device the list of the one or more tasks to be performed comprises providing an audio representation of the list.

10. A home care administration system comprising:
a communication device;
means for providing a schedule of one or more visits via the communication device;
means for providing and receiving task information for the one or more visits via the communication device; and
means for tracking the location of the communication device.

11. The system of claim 10, wherein the means for providing the schedule of one or more visits comprise means for determining the schedule based on at least one of (1) the location of the communication device, (2) an expertise level of a caregiver that is to perform the one or more visits, and (3) whether the caregiver has previously conducted a visit at a particular location.

12. The system of claim 10, wherein the means for providing the schedule of one or more visits comprise means for determining the schedule based on at least one (1) a location of a patient, (2) a care plan status of the patient, and (3) a condition of the patient.

13. The system of claim 10, wherein the means for tracking the location of the communication device comprise:
means for determining a shortest path between a location of the communication device and a location of a patient, wherein the location of the patient is stored in an office administration server system, and wherein the shortest path is determined at the office administration server system, and
means for providing the shortest path to the communication device.

14. The system of claim 10, wherein the means for tracking the location of the communication device comprise means for determining a distance that the communication device travels, and for storing the determined distance in a database at an office administration server system.

15. The system of claim 10, wherein the means for providing the schedule of the one or more visits comprise means for providing a textual representation of the schedule, and wherein the means for providing and receiving the task information for the one or more visits comprises providing a textual representation of the task information.

16. The system of claim 10, wherein the means for providing the schedule of the one or more visits comprise means for providing an audio representation of the schedule, and wherein the means for providing and receiving the task information for the one or more visits comprises providing an audio representation of the task information.

17. A method comprising:
receiving at a communication device a transmission across a communication network from a server system, wherein the transmission includes a representation of tasks defined by a patient-specific care plan associated with a patient;
presenting one or more prompts via the communication device associated with the tasks;
accepting inputs at the communication device from a caregiver performing a visit for the patient, wherein the inputs correspond to the tasks in the patient-specific care plan; and
transmitting the inputs from the communication device across the communication network to the server system.

18. The method of claim 17, further comprising:
receiving at the communication device real-time schedule information across the communication network from the server system, wherein the schedule information comprises a list of one or more visits to be performed, and wherein the patient-specific care plan is associated with the visit; and
the communication device presenting the real-time schedule information to the caregiver.

19. The method of claim 17, further comprising:
determining a shortest path between a location of the communication device and a location of a patient, wherein the shortest path is determined at the server system; and
presenting the shortest path to the caregiver via the communication device.

20. The method of claim 17, further comprising:
determining a distance that the communication device travels; and
storing the determined distance in a database at the server system.
